(19) United States
(12) Patent Application Publication
(10) Pub. No.: US 2024/0381203 A1
(43) Pub. Date: Nov. 14, 2024

(54) NO TRANSMIT ZONE SIGNALING FOR AERIAL UES

(71) Applicant: QUALCOMM Incorporated, San Diego, CA (US)

(72) Inventors: Chiranjib SAHA, Lakeside, CA (US); Alberto RICO ALVARINO, San Diego, CA (US); Umesh PHUYAL, San Diego, CA (US); Le LIU, San Jose, CA (US)

(21) Appl. No.: 18/653,652

(22) Filed: May 2, 2024

Related U.S. Application Data
(60) Provisional application No. 63/501,052, filed on May 9, 2023.

(51) Int. Cl. H04W 36/08; H04W 36/32; H04W 76/20; H04W 84/06

(52) U.S. Cl. CPC H04W 36/08; H04W 36/322; H04W 48/18; H04W 76/20; H04W 84/06

(57) ABSTRACT

A method of wireless communication at a UE is disclosed herein. The method includes receiving, from a network node, a configuration associated with a radio resource control (RRC) inactive state or an RRC idle state, wherein the configuration indicates a transmission limitation for a frequency band for aerial devices within a geographic area. The method further includes performing at least one of at least one of a cell selection or a cell reselection, based on a condition of the UE being an aerial device and based on the configuration indicating the transmission limitation.

### CROSS REFERENCE TO RELATED APPLICATION(S)

This application claims the benefit of and priority to U.S. Provisional Application Ser. No. 63/501,052, entitled “No Transmit Zone Signaling for Aerial UEs” and filed on May 9, 2023, which is expressly incorporated by reference herein in its entirety.

### TECHNICAL FIELD

The present disclosure relates generally to communication systems, and more particularly, to aerial user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes at least one memory; and at least one processor coupled to the at least one memory and, based at least in part on information stored in the at least one memory, the at least one processor is configured to: receive, from a network node, a configuration indicating a transmission limitation for a frequency band for aerial devices within a geographic area; and perform at least one of cell selection, cell reselection, measurement reporting, or a conditional handover based on a condition of the UE being an aerial device and based on the configuration indicating the transmission limitation.

In an aspect of the disclosure, a method, a computer-readable medium, and an apparatus for wireless communication at a network node are provided. The apparatus includes at least one memory; and at least one processor coupled to the at least one memory and, based at least in part on information stored in the at least one memory, the at least one processor is configured to: transmit, for a user equipment (UE), a configuration indicating a transmission limitation for a frequency band for aerial devices within a geographic area; and receive an indication of at least one of cell selection, cell reselection, measurement reporting, or conditional handover based on a condition of the UE being an aerial device and based on the configuration indicating the transmission limitation.

In an aspect of the disclosure, a method, a computer-readable medium, and an apparatus for wireless communication at a user equipment (UE) are provided. The apparatus includes at least one memory; and at least one processor coupled to the at least one memory and, based at least in part on information stored in the at least one memory, the at least one processor is configured to: receive, from a network node, a configuration associated with a radio resource control (RRC) inactive state or an RRC idle state, wherein the configuration indicates a transmission limitation for a frequency band for aerial devices within a geographic area; and perform at least one of a cell selection or a cell reselection based on a condition of the UE being an aerial device and based on the configuration indicating the transmission limitation.

In an aspect of the disclosure, a method, a computer-readable medium, and an apparatus for wireless communication at a network node are provided. The apparatus includes at least one memory; and at least one processor coupled to the at least one memory and, based at least in part on information stored in the at least one memory, the at least one processor is configured to: transmit, for a user equipment (UE), a configuration associated with a radio resource control (RRC) inactive state or an RRC idle state, wherein the configuration indicates a transmission limitation for a frequency band for aerial devices within a geographic area; and receive an indication of at least one of a cell selection or a cell reselection, based on a condition of the UE being an aerial device and based on the configuration indicating the transmission limitation.

In an aspect of the disclosure, a method, a computer-readable medium, and an apparatus for wireless communication at a user equipment (UE) are provided. The apparatus includes at least one memory; and at least one processor coupled to the at least one memory and, based at least in part on information stored in the at least one memory, the at least one processor is configured to: receive, from a network node for an RRC connected mode, a configuration associated with a radio resource control (RRC) connected mode, wherein the configuration is for transmission of a measurement report or a conditional handover based on a location of the UE within a geographic area; and perform at least one of the measurement report or the conditional handover based on the configuration.

In an aspect of the disclosure, a method, a computer-readable medium, and an apparatus for wireless communication at a network node are provided. The apparatus includes at least one memory; and at least one processor coupled to the at least one memory and, based at least in part on information stored in the at least one memory, the at least one processor is configured to: receive an indication of a location of a user equipment (UE) in a radio resource control (RRC) connected mode; and transmit, based on a location of the UE being within a geographic area, a configuration for transmission of a measurement report or a conditional handover based on a location of the UE within a geographic area.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B are diagrams illustrating example aspects of a no transmit zone (NTZ).

FIG. 5 is a diagram illustrating example aspects of configurations pertaining to NTZs.

FIG. 6 is a diagram illustrating example aspects of measurement reporting associated with an NTZ.

FIG. 7 is a diagram illustrating example aspects of indicating NTZ information.

FIG. 8 is a communication flow diagram between an aerial UE and a base station.

FIG. 9 is a flowchart of a method of wireless communication at a UE, in accordance with various aspects of the present disclosure.

FIG. 10 is a flowchart of a method of wireless communication at a network node, in accordance with various aspects of the present disclosure.

FIG. 11 is a diagram illustrating an example of a hardware implementation for an example apparatus.

FIG. 12 is a diagram illustrating an example of a hardware implementation for an example network entity.

FIG. 13 is a flowchart of a method of wireless communication at a UE, in accordance with various aspects of the present disclosure.

FIG. 14 is a flowchart of a method of wireless communication at a network node, in accordance with various aspects of the present disclosure.

FIG. 15 is a flowchart of a method of wireless communication at a UE, in accordance with various aspects of the present disclosure.

FIG. 16 is a flowchart of a method of wireless communication at a network node, in accordance with various aspects of the present disclosure.

### DETAILED DESCRIPTION

A UE may be configured with the capability to communicate in an aerial manner. For example, the UE may be located at an aerial device or the UE may be a component of the aerial device with the capability for flight. Such a UE may be referred to as an aerial UE. When an aerial UE is located within a no transmit zone (NTZ) of a frequency band, the aerial UE may cause interference to operations of systems that use radio access technologies when the aerial UE transmits in UL. Among various examples, the transmissions from an aerial UE may cause interference to wireless communication systems, radio astronomy, radars, or satellite services. An NTZ may refer to a region having an associated restriction on transmissions in one or more frequency bands within the region. For instance, the interference caused by the aerial UE's transmissions may be due to an altitude of the aerial UE. In order to avoid or reduce such interference, an aerial UE may not be allowed to transmit beyond a certain transmission power within a certain frequency band when the aerial UE is located in an NTZ. In some aspects, the restriction may be further based on the aerial UE being in a flying state or being above a height threshold. In some aspects, the NTZ may be defined for a particular height range having a minimum and/or maximum height threshold above a ground level. In some aspects, the UE may be restricted from transmitting in the frequency band while located in the NTZ. Some wireless communication systems (e.g., 5G NR) may not have a defined manner of configuring an aerial UE for operation in an NTZ. Furthermore, such wireless communication systems may not have a defined manner for an aerial UE to convey NTZ-related information to a base station.

Various aspects relate generally to aerial UEs. Some aspects more specifically relate to operation and communication for aerial UEs in NTZs. In some examples, a UE receives, from a network node, a configuration indicating a transmission limitation for a frequency band for aerial devices within a geographic area (e.g., an NTZ). The UE performs at least one of cell selection, cell reselection, measurement reporting, or a conditional handover based on a condition of the UE being an aerial device and based on the configuration indicating the transmission limitation. In some aspects, the UE may further perform the cell selection, cell reselection, measurement reporting, or the conditional handover based on the UE being located within the geographic area (e.g., NTZ).

Particular aspects of the subject matter described in this disclosure can be implemented to realize one or more of the following potential advantages. In some examples, by receiving the configuration and performing cell selection, cell reselection, measurement reporting, and/or a conditional handover based on the configuration, the described techniques may enable an aerial UE to comply with NTZ regulations. As such, vis-à-vis the aforementioned configuration, the aerial UE may avoid causing interference to other RAT-dependent systems near/around a base station.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

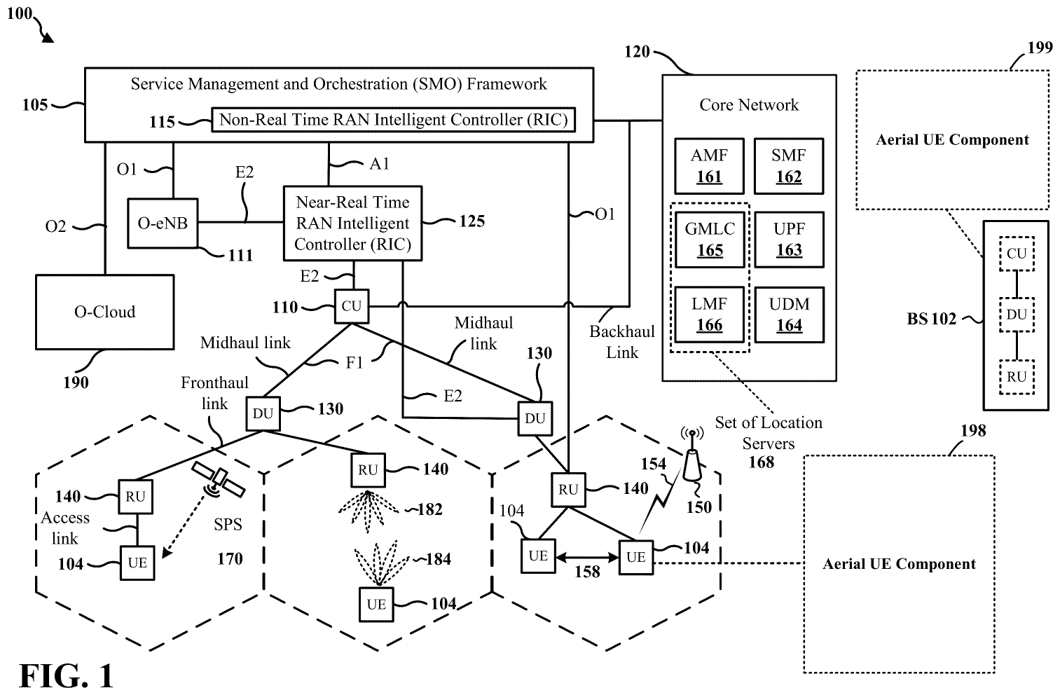

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-CNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an aerial UE component 198 that may be configured to receive, from a network node, a configuration indicating a transmission limitation for a frequency band for aerial devices within a geographic area; and perform at least one of cell selection, cell reselection, measurement reporting, or a conditional handover based on a condition of the UE being an aerial device and based on the configuration indicating the transmission limitation. In certain aspects, the base station 102 may have an aerial UE component 199 that may be configured to transmit, for a user equipment (UE), a configuration indicating a transmission limitation for a frequency band for aerial devices within a geographic area; and receive an indication of at least one of cell selection, cell reselection, measurement reporting, or conditional handover based on a condition of the UE being an aerial device and based on the configuration indicating the transmission limitation. Although the description herein may focus on 5G NR, the concepts presented herein may also be applicable to other types of wireless communications systems as well.

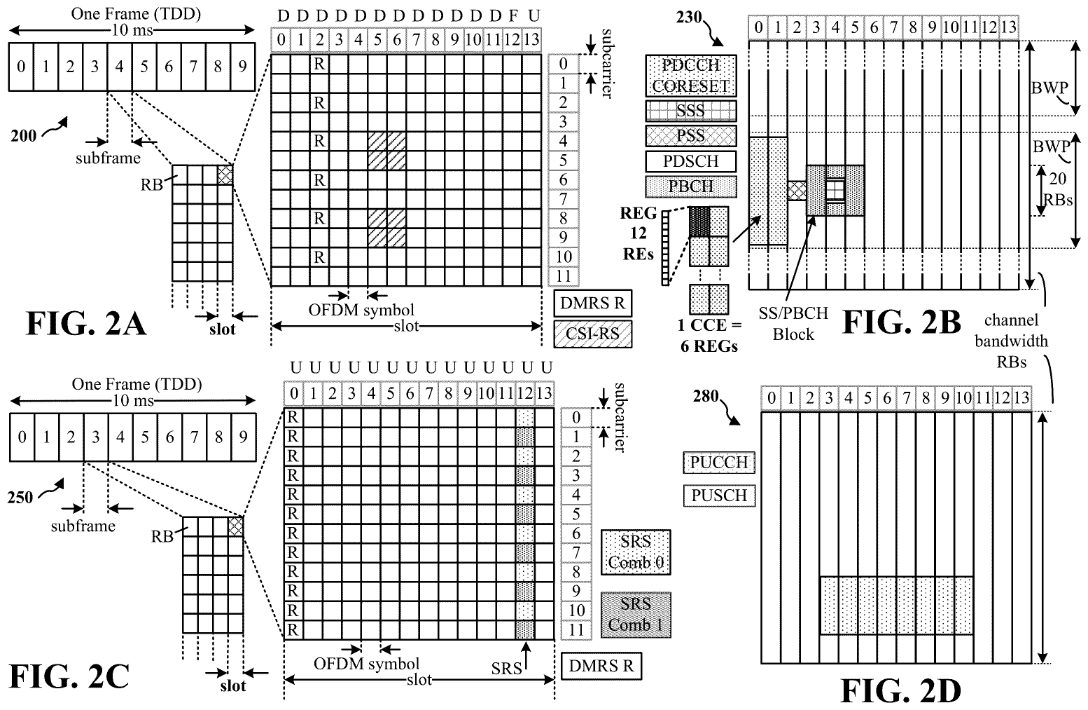

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

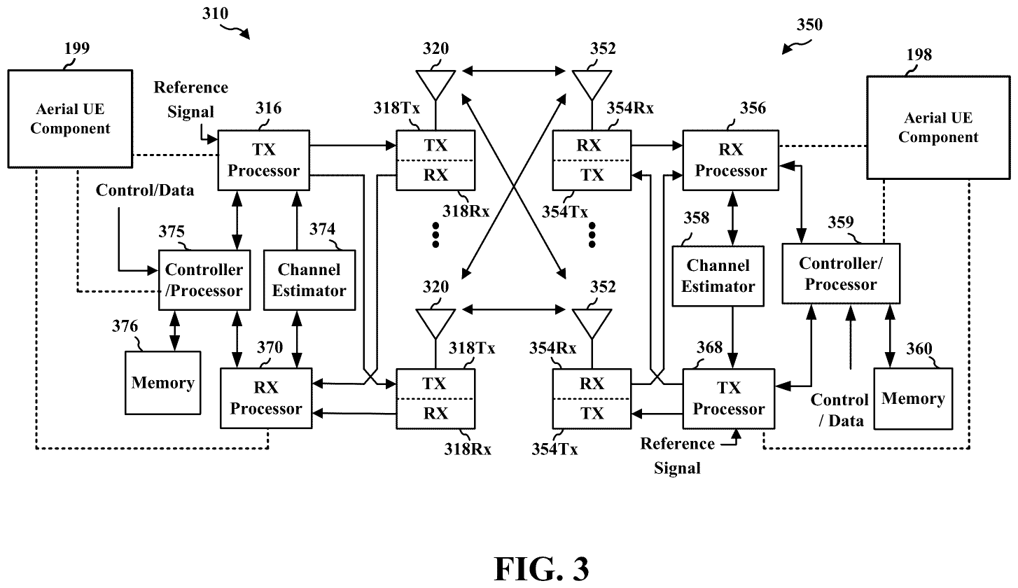

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the aerial UE component 198 of FIG. 1.

At least one of the TX processor 316, the RX processor 370, and the controller/processor 375 may be configured to perform aspects in connection with the aerial UE component 199 of FIG. 1.

An aerial UE (may refer to a UE that is capable of flight or of operating at a height above a ground level. For example, the aerial UE may be located on or a component of an aerial device. Among other examples, the UE may be located on or a component of an unmanned aerial vehicle (UAV) or a drone. In some aspects, the aerial UE may be configured to transmit a measurement report based on configured height thresholds. The aerial UE may also be configured to report a height, a location, and a speed of the aerial UE in the measurement report. Furthermore, the aerial UE may also be configured to report a flight path of the aerial UE in the measurement report. Measurement reporting may be based on a configured number of cells (e.g., more than one cell) fulfilling report triggering criteria simultaneously. Aspects presented herein provide for improved measurement reporting from aerial UEs based on an aerial UE approaching a NTZ or based on the aerial UE leaving the NTZ.

Aerial UEs may be subject to regulatory measures. For instance, regulations may specify a no transmit zone (NTZ) around a base station, where the NTZ is imposed in order to limit transmissions from drones in order to reduce an amount of interference to the base station. For instance, UL communications from an aerial UE may create interference to operations of victim systems, such as radio astronomy, radar, and fixed satellite services. To mitigate this interference, when an aerial UE is in an NTZ and operating in a flying state, the aerial UE may operate with UL transmission limitations and/or the UE may perform additional filtering to reduce secondary harmonics. An NTZ may also be referred to as a “no-fly zone.”

An aerial UE may perform cell selection. Public land mobile network (PLMN) selection may be based on PLMN selection principles. Cell selection may occur on transition from a registration management deregistered state (RM-DEREGISTERED) to a registration management registration state (RM-REGISTERED), from a connection management idle state (CM-IDLE) to a connection management connection state (CM-CONNECTED), and from CM-connected to CM-IDLE based on the following principles below.

First, a UE non-access stratum (NAS) layer may identify a selected PLMN and equivalent PLMNs. Second, cell selection may be based on cell definition SSBs (CD-SSBs) located on a synchronization raster. Third, a UE may search NR frequency bands in order to identify a strongest cell for each carrier frequency as per a cell definition SSB (CD-SSB). The UE may read broadcasted cell system information in order to identify PLMN(s). The UE may search each carrier in turn (“initial cell selection”) or utilize stored information to shorten the search of each carrier (“stored information cell selection”). Fourth, a UE may seek to identify a suitable cell. If the UE is not able to identify a suitable cell, the UE may seek to identify an acceptable cell. When a suitable cell or an acceptable cell is found, the UE may camp on the suitable/acceptable cell and comment cell reselection procedures. A suitable cell may be a cell for which (1) measured cell attributes satisfy cell selection criteria, (2) the cell PLMN is a selected PLMN, a registered PLMN, or an equivalent PLMN, and (3) the cell is not barred or reserved and the cell is not part of a tracking area which is in a list of “forbidden tracking areas in roaming.” An acceptable cell may refer to (1) a cell for which measured cell attributes satisfy cell selection criteria and (2) the cell is not barred. Fifth, an IAB mobile terminal (IAB-MT) may apply a cell selection procedure similar to that of a UE with the following differences: (1) an IAB-MT may ignore cell-barring or cell-reservation indications included in a cell system information broadcast and (2) an IAB-MT may consider a cell as a candidate for cell selection if a cell system information broadcast indicates IAB support for a selected PLMN or a selected standalone non-public network (SNPN).

On a transition from a radio resource control connected state (RRC_CONNECTED) to a radio resource control idle state (RRC_IDLE) or on a transition from RRC_CONNECTED to a radio resource control inactive state (RRC_INACTIVE), a UE may camp on a cell as a result of cell selection according to a frequency assigned by RRC in a state transition message. When recovering from being in an out of coverage state, a UE may attempt to find a suitable cell in a manner described for stored information (“stored information cell selection”) or initial cell selection as described above. If no suitable cell is found on a frequency or a radio access technology (RAT), the UE may attempt to find an acceptable cell. In the case of multi-beam operations, a cell quality may be derived amongst beams corresponding to the same cell.

An aerial UE may perform cell reselection. A UE in RRC_IDLE (and RRC_INACTIVE) may perform cell reselection according to the following principles below. First, cell reselection may be based on CD-SSBs located on a synchronization raster. Second, a UE may perform measurements of attributes of a serving cell and neighbor cells to enable a reselection process. For instance, for the search and measurement of inter-frequency neighboring cells, a carrier frequency may be indicated as part of the reselection process. Third, cell reselection may identify a cell on which the UE is to camp. Cell reselection may be based on cell reselection criteria which is associated with measurements performed on the serving cell and the neighbor cells. Intra-frequency reselection may be based on a ranking of cells. Inter-frequency reselection may be based on absolute priorities where a UE attempts to camp on a cell that has a highest priority frequency available. A neighbor cell list (NCL) may be provided by the serving cell to handle specific cases for intra-frequency neighbor cells and inter-frequency neighbor cells. Allow-lists may also be provided to request that the UE is to reselect specific intra-frequency neighbor cells and specific inter-frequency neighbor cells. Cell reselection may be speed dependent or cell reselection may be based on service specific prioritization. Slice-based cell reselection information may be provided to facilitate a UE selecting a cell that supports specific slices.

Cell reselection evaluation procedures may be associated with priority handling. For instance, absolute priorities of different frequencies of a single RAT or different inter-RAT frequencies may be provided to a UE (e.g., an aerial UE) in system information, in a RRC release message, or by inheritance from another RAT at inter-RAT cell (re) selection. As one, non-limiting example, the different frequencies of the single RAT may be different frequencies for NR. In the case of system information, a single RAT frequency or an inter-RAT frequency may be listed without providing a priority (i.e., the field “cellReselectionPriority” may be absent for the single RAT frequency or for the inter-RAT frequency). If a field for cell reselection priority (e.g., such as cellReselectionPriority or nsag-cellReselectionPriority) are provided in dedicated signaling, a UE may ignore fields with the corresponding reselection priority (e.g., cellReselectionPriority or nsag-cellReselectionPriority) that the UE received in system information.

If a UE is camped on a cell state, the UE may apply priorities provided by system information from a current cell and the UE may preserve priorities provided by dedicated signaling and a deprioritization request (“deprioritizationReq”) received in a radio resource control release (RRCRelease message) unless otherwise specified. When the UE is camped in a normal state and has dedicated priorities other than priorities of a current frequency, a UE may consider the current frequency to be a lowest priority frequency (i.e., lower than network configured values). In a case in which the UE receives a RRCRelease message with a deprioritizationReq, the UE may consider a current frequency and stored frequencies due to a previously received RRCRelease message deprioritizationReq or all frequencies of NR to be a lowest priority frequency (i.e., lower than the network configured values) while a time is running (e.g., a T325 time) is running irrespective of a camped RAT. The UE may delete stored deprioritization request(s) when a PLMN selection or a SNPN selection is performed on request by a NAS. A UE may perform cell reselection evaluation for NR frequencies and for inter-RAT frequencies that are included in system information and for which the UE has a priority provided. A prioritization among frequencies which the UE considers to be a highest priority frequency may be left to UE implementation.

A UE may delete priorities provided by dedicated signaling when (1) the UE enters a different RRC state, (2) an optional validity time of dedicated priorities (T320) expires, (3) the UE receives an RRCRelease message with a field of cellReselectionPriorities absent, or (4) a PLMN selection or an SNPN are performed on request by a NAS. The UE may not consider exclude-listed cells as candidates for cell reselection. The UE may consider allow-listed cells, if configured, as candidates for cell reselection. A UE in a RRC_IDLE state may inherit priorities provided by dedicated signaling and a remaining validity time (e.g., T320 in NR and extended universal mobile telecommunications system terrestrial radio access (E-UTRA)), if configured, at inter-RAT cell (re) selection.

Various aspects pertaining to RRCRelease are presented below.

```
RRCRelease-IEs ::= SEQUENCE {
redirectedCarrierInfo RedirectedCarrierInfo OPTIONAL, -- Need N
cellReselectionPriorities CellReselectionPriorities OPTIONAL, -- Need R
suspendConfig SuspendConfig OPTIONAL, -- Need R
deprioritisationReq SEQUENCE {
  deprioritisationType ENUMERATED {frequency, nr},
  deprioritisationTimer ENUMERATED {min5, min10, min15, min30}
} OPTIONAL, -- Need N
lateNonCriticalExtension OCTET STRING OPTIONAL,
nonCriticalExtension RRCRelease-v1540-IEs OPTIONAL
}
CellReselectionPriorities ::= SEQUENCE {
freqPriorityListEUTRA FreqPriorityListEUTRA OPTIONAL, -- Need M
freqPriorityListNR FreqPriorityListNR OPTIONAL, -- Need M
t320 ENUMERATED {min5, min10, min20, min30, min60, min120,
min180, spare1} OPTIONAL, -- Need R
...,
[[
freqPriorityListDedicatedSlicing-r17 FreqPriorityListDedicatedSlicing-r17
OPTIONAL -- Need M
]]
}
```

Table 2 below presents further aspects pertaining to a T320 timer.

TABLE 2
T320 Timer

| Timer | Start | Stop | At Expiry |
|---|---|---|---|
| T320 | Upon reception of | Upon entering | Discard cell |
| | T320 or upon cell | RRC_CONNECTED, | reselection |
| | (re)selection to NR | upon reception of an | priority |
| | from another RAT | RRCRelease message, | information |
| | with a validity time | when PLMN selection | provided by |
| | configured for | or SNPN selection is | dedicated |
| | dedicated priorities | performed on request | signaling |
| | (in which case a | by NAS, when the UE | |
| | remaining validity | enters RRC_IDLE from | |
| | time may be | RRC_INACTIVE, or | |
| | applied) | upon cell (re)selection | |
| | | to another RAT (in which | |
| | | case the time is carried | |
| | | on to another RAT) | |

As stated above, a UE may delete priorities provided by dedicated signaling when (1) the UE enters a different RRC state, (2) an optional validity time of dedicated priorities (T320) expires, (3) the UE receives an RRCRelease message with a field of cellReselectionPriorities absent, or (4) a PLMN selection or an SNPN selection are performed on request by a NAS.

As presented herein, an aerial UE may perform cell selection or cell reselection in a different manner than other UEs based on being located in or having received an indication of an NTZ. For example, a UE (e.g., an aerial UE) may perform cell (re) selection based on system information (i.e., based on a system information block (SIB)). System information block type 3 (SIB-3) may include information about a serving frequency and intra-frequency neighbor cells relevant for cell reselection (including cell reselection parameters common for a frequency and cell specific reselection parameters). Some SIBs may include information about frequencies and inter-frequency neighbor cells relevant for cell selection and reselection for a particular RAT. In some aspects, SIBs may be provided for a single RAT. In other aspects, information may be provided for multiple RATs. As a non-limiting example, system information block type 4 (SIB-4) may include information about other NR frequencies and inter-frequency neighbor cells relevant for cell reselection (including cell reselection parameters common for a frequency and cell specific reselection parameters), which may also be used for NR idle/inactive measurements. System information block type 5 (SIB-5) may include information about E-UTRA frequencies and E-UTRA neighbor cells relevant for cell reselection (including cell reselection parameters common for a frequency and cell specific reselection parameters).

When a UE is in a RRC_IDLE state, a UE may seek to identify a suitable cell. If the UE is not able to identify a suitable cell, the UE may identify an acceptable cell. When a suitable/acceptable cell is found, the UE may camp on the suitable/acceptable cell and the UE may commence a cell reselection procedure. As noted above, a suitable cell may be a cell for which (1) measured cell attributes satisfy cell selection criteria, (2) the cell PLMN is a selected PLMN, a registered PLMN, or an equivalent PLMN, and (3) the cell is not barred or reserved and the cell is not part of a tracking area which is in a list of “forbidden tracking areas in roaming.” An acceptable cell may refer to (1) a cell for which measured cell attributes satisfy cell selection criteria and (2) the cell is not barred.

In certain areas (i.e., zones), a UAV may not be allowed to transmit or to transmit beyond a certain power at a given frequency band, that is, some frequency bands may be associated with an NTZ. Various technologies pertaining to configuring and signaling NTZ configurations to UAVs are described herein, where the UAVs may be in an RRC_IDLE state, an RRC_INACTIVE state, or an RRC_CONNECTED state. Furthermore, various technologies pertaining to a UE indicating NTZ information to a base station (e.g., a gNB) are also described herein.

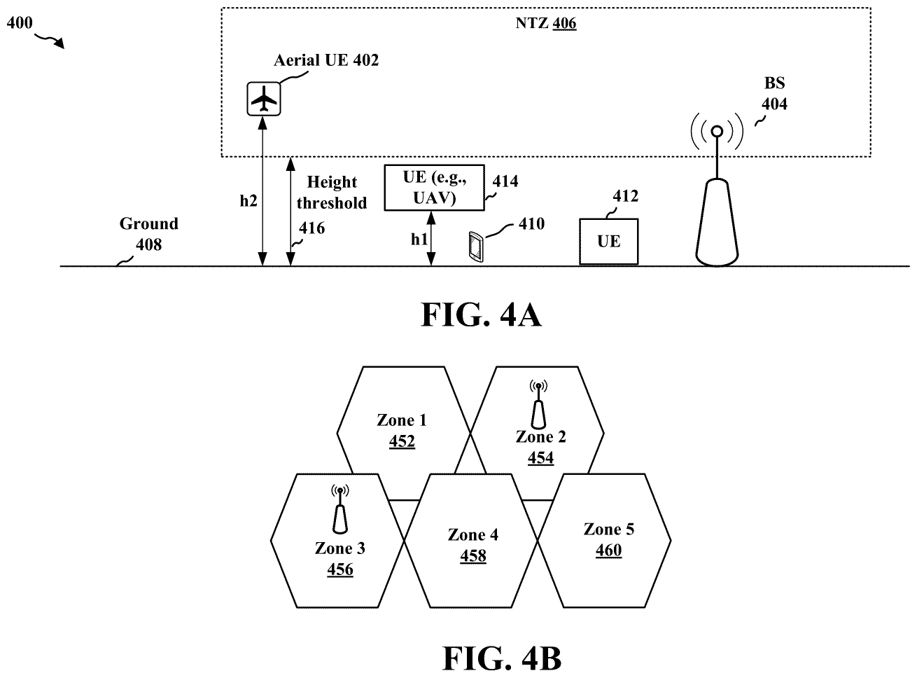

FIG. 4A is a diagram 400 illustrating example aspects of an NTZ. The diagram 400 depicts an aerial UE 402 (e.g., a drone) and a base station 404 (e.g., a gNB). A UE may be considered to be an aerial UE when the UE is subscribed as an aerial UE (e.g., has a subscription as an aerial UE) and/or when the UE is in a flying state or aerial state. The aerial state or flying state may be defined as, or configured as, a state in which a UE is located a threshold distance, e.g., 416, from a ground 408. For example, the UE 414 may not be considered an aerial UE, and the UE 402 may be considered an aerial UE based on their respective heights, even if both UEs have an aerial subscription and/or are capable of aerial operation. The aerial UE 402, or a device in which the aerial UE is comprised, may include hardware (e.g., propeller(s)) that enable the aerial UE to be in a flying state. An NTZ 406 may be defined (e.g., by regulations) around the base station 404. When the aerial UE 402 transmits in UL when the aerial UE 402 is within the NTZ 406, the aerial UE 402 may cause interference to systems that depend on RAT communications. For instance, when the aerial UE 402 flies above an antenna of the base station 404, there may be a high likelihood of line-of-sight (LOS) propagation conditions to other base stations (not shown in FIG. 4A). In such a scenario, an UL transmission of the aerial UE 402 may become visible and may cause interference to the other base stations. If the interference is not controlled and/or mitigated, the interference may cause issues with UL transmissions of other UEs, such as a ground-based UE 410 or 412 (e.g., a cell phone or other type of UE). In comparison to the aerial UE 402, the ground-based UE 410 may not be capable of operating in a flying state. For instance, the ground-based UE 410 may not include hardware (e.g., propeller(s)) that facilitate flying. The NTZ 406 may be a zone around the base station 404. In one example, the NTZ 406 may be in the form of a polygon with hysteresis, a circle with hysteresis, or an ellipse with hysteresis. Hysteresis may refer to a phenomenon in which a value of a physical property lags behind changes in the effect causing it. Aspects of hysteresis will be discussed in greater detail below. In another example, the NTZ 406 may be a closed shape or a union of closed shape. In another example, the NTZ 406 may be a three-dimensional (3D) zone. In a further example, the NTZ 406 may be indicated by a two-dimensional (2D) zone and a height range, where the 2D zone and the height range define the NTZ 406.

A UE may be configured with the capability to operate or move at a height above the ground. As an example, the UE may be located in or part of a device with the capability to fly. Such a UE may be referred to as an aerial UE. When an aerial UE is flying (e.g., above a height threshold) and is located within a no transmit zone (NTZ) of a base station or other communication device, the aerial UE may cause interference to operations of systems that use radio access technologies when the aerial UE transmits in UL. For instance, the interference may be due to an altitude of the aerial UE. In order to avoid causing such interference, an aerial UE may not be allowed to transmit beyond a certain power at a certain frequency band when the aerial UE is located in an NTZ and when the aerial UE is in a flying state. FIG. 4B illustrates an example of multiple zones, e.g., 452, 454, 456, 458, and 460. One or more of the zones may correspond to an NTZ. In some aspects, each of the zones may be an NTZ, and different zones may have different restrictions on wireless transmissions within the corresponding zone. For example, zone 452 may restrict transmissions from aerial devices within a first frequency range, and zone 454 may restrict transmissions from aerial devices within a second frequency range. The restrictions for different zones may be for different types of aerial devices. For example, zone 3 may restrict transmissions from aerial devices that are operating above a height threshold (e.g., such as shown at 416 in FIG. 4A), zone 4 may restrict transmissions from aerial devices that are operating above a different height threshold, and zone 5 may restrict transmissions from aerial devices having a particular type of subscription. FIG. 4A shows an example of a UE 414, e.g., which may be a component of a UAV or other device capable of flight, and which is at a height h1 below the height threshold 416. In some aspects, the UE 414 may not be subject to NTZ transmission restrictions as it is not in an aerial state above the height threshold 416.

Aspects presented herein enable an aerial UE to be configured for behavior within an NTZ and provide mechanisms for an aerial UE to convey NTZ-related information to a base station.

Various technologies pertaining to NTZ signaling for aerial UEs are described herein. In an example, a UE receives, from a network node, a configuration indicating a transmission limitation for a frequency band for aerial devices within a geographic area (e.g., an NTZ). The UE performs at least one of cell selection, cell reselection, measurement reporting, or a conditional handover based on a condition of the UE being an aerial device and based on the configuration indicating the transmission limitation. Vis-à-vis the aforementioned configuration, an aerial UE may perform cell selection, cell reselection, measurement reporting, and/or a conditional handover in a different manner for NTZs. As such, vis-à-vis the aforementioned configuration, the aerial UE may avoid or reduce interference to other RAT-dependent systems near/around a base station.

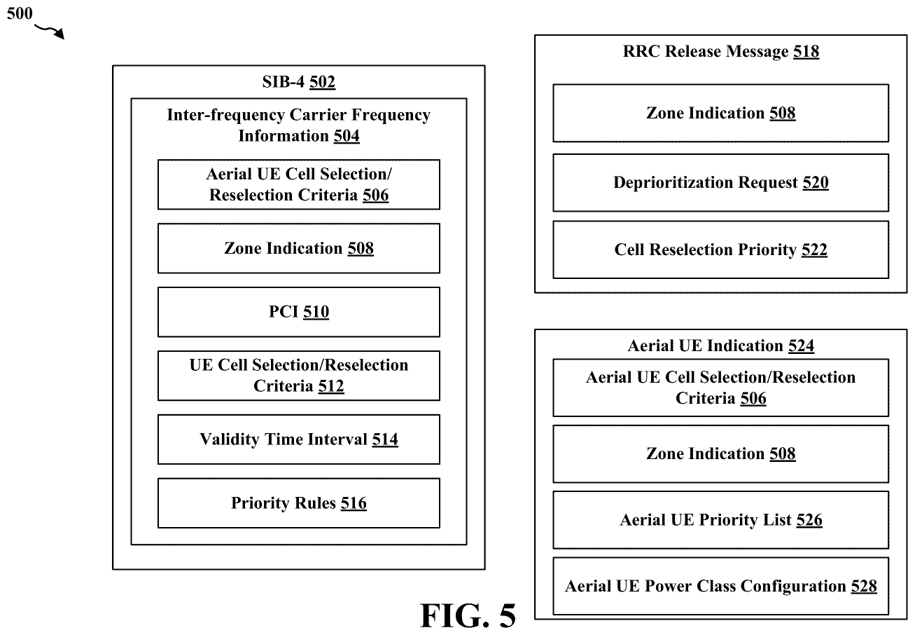

FIG. 5 is a diagram 500 illustrating example aspects of configurations pertaining to NTZs. A UE (e.g., an aerial UE) may perform cell selection and/or cell reselection based on cell selection criteria (which may be referred to as “cell selection criterion S,” “cell selection criteria S,” “S criteria,” or “S criterion”). For instance, the UE may select or reselect a cell when the following is true:

$$Srxlev > 0 \qquad ( I )$$

$$AND$$

$$Squal > 0$$

$$where :$$

$$( II )$$

$$Srxlev = {Q}_{rxlevmeas} - ( {Q}_{rxlev min} + {Q}_{rxlevminoffset} ) - {P}_{compensation} - {Qoffset}_{temp}$$

$$Squal = {Q}_{qualmin} - ( {Q}_{qualmin} + {Q}_{qualminoffset} ) - Q {offset}_{temp} \qquad ( III )$$

In (I)-(III) above, Srxlev may refer to a cell selection Rx level value in dB, Squal may refer to a cell selection quality value in dB, Qᵣₓₗₑᵥₘₑₐₛ may refer to a measured reference signal received power (RSRP) value of a cell that a UE is evaluating, Qᵣₓₗₑᵥₘᵢₙ may refer to a minimum RX level in a cell measured in dbM, Q_{rxlevminoffset} may refer to an offset to Qᵣₓₗₑᵥₘᵢₙ taken into account in a Srxlev evaluation as a result of a periodic search for a higher priority PLMN while camped normally on a visiting PLMN (VPLMN), Q_{qualminoffset} may refer to an offset to Q_{qualmin} taken into account in the Squal evaluation as a result of a periodic search for a higher priority PLMN while camped normally on a VPLMN, P_{compensation} may refer to a power class compensation, and Qoffsetₜₑₘₚ may refer to an offset temporarily applied to a cell.

Various aspects pertaining to NTZ handling when a UE is in an RRC_INACTIVE or an RRC_IDLE state are presented below. In one aspect, for a specific frequency band, a network (i.e., a base station) may indicate separate S criterion related parameters in a SIB-4 (or another SIB or another type of message), where the separate S criterion related parameters may be applicable if the UE is an aerial UE (e.g., based on UE subscription and if the UE is in an indicated 3D zone). The indicated 3D zone may be in the form of a polygon with hysteresis, a circle with hysteresis, or an ellipse with hysteresis.

Various aspects pertaining to the aforementioned SIB-4 when a UE (e.g., an aerial UE) is in an RRC_INACTIVE state or an RRC_IDLE state are presented below.

SIB4 ::= SEQUENCE {
interFreqCarrierFreqList InterFreqCarrierFreqList,
lateNonCriticalExtension OCTET STRING OPTIONAL,
...,
[[
interFreqCarrierFreqList-v1610 InterFreqCarrierFreqList-v1610
OPTIONAL -- Need R
]],
[[
interFreqCarrierFreqList-v1700 InterFreqCarrierFreqList-v1700
OPTIONAL -- Need R
]],
[[
interFreqCarrierFreqList-v1720 InterFreqCarrierFreqList-v1720
OPTIONAL -- Need R
]],
[[
interFreqCarrierFreqList-v1730 InterFreqCarrierFreqList-v1730
OPTIONAL -- Need R
]]
}
InterFreqCarrierFreqInfo ::= SEQUENCE {
dl-CarrierFreq ARFCN-ValueNR,
frequencyBandList MultiFrequencyBandListNR-SIB OPTIONAL, --
Cond Mandatory
frequencyBandListSUL MultiFrequencyBandListNR-SIB OPTIONAL, --
Need R
nrofSS-BlocksToAverage INTEGER (2..maxNrofSS-BlocksToAverage)
OPTIONAL, -- Need S
absThreshSS-BlocksConsolidation ThresholdNR OPTIONAL, -- Need S
smtc SSB-MTC OPTIONAL, -- Need S
ssbSubcarrierSpacing SubcarrierSpacing,
ssb-ToMeasure SSB-ToMeasure OPTIONAL, -- Need S
deriveSSB-IndexFromCell BOOLEAN,
ss-RSSI-Measurement SS-RSSI-Measurement OPTIONAL, -- Need R
q-RxLevMin Q-RxLevMin,
q-RxLevMinSUL Q-RxLevMin OPTIONAL, -- Need R
q-QualMin Q-QualMin OPTIONAL, -- Need S
p-Max P-Max OPTIONAL, -- Need S
t-ReselectionNR T-Reselection,
t-ReselectionNR-SF SpeedStateScaleFactors OPTIONAL, -- Need S
threshX-HighP ReselectionThreshold,
threshX-LowP ReselectionThreshold,
threshX-Q SEQUENCE {
threshX-HighQ ReselectionThresholdQ,
threshX-LowQ ReselectionThresholdQ
} OPTIONAL, -- Cond RSRQ
cellReselectionPriority CellReselectionPriority OPTIONAL, -- Need R
cellReselectionSubPriority CellReselectionSubPriority OPTIONAL, --
Need R
q-OffsetFreq Q-OffsetRange DEFAULT dB0,
interFreqNeighCellList OPTIONAL, -- Need R
interFreqExcludedCellList InterFreqExcludedCellList OPTIONAL, --
Need R
...
}

In one aspect, in “InterFreqCarrierFreqInfo” of SIB-4, a network (e.g., a base station) may indicate additional, and/or different, values of Qᵣₓₗₑᵥₘᵢₙ and/or P_{compensation} for use by aerial UEs, where the additional values may be equal to an additional power backoff for UL transmissions for an aerial UE. The network may also indicate additional, and/or different, parameters related to S-criterion evaluation in the SIB-4 for use by aerial UEs. The additional values (or the different parameters) may be placed inside of a container of the SIB-4 so that the additional values (or the additional parameters) are applicable if the UE is an aerial UE (i.e., the UE has an aerial subscription and/or the UE is preconfigured to read the container). The container may also include an indication of a physical cell ID (PCI). The container may be referred to as a configuration and/or the configuration may be included in the container. The container may also indicate a zone (e.g., such as a 2D or 3D zone) for which the configuration may overwrite a second configuration (e.g., a configuration for non-aerial UEs) indicated in the SIB-4. As an example, the zone may be a 2-D zone with a height range. For example, FIG. 4B illustrates examples of 2-D zones, and FIG. 4A illustrates an example of a height range. When a UE is outside of the zone, the UE may apply the second configuration. When the UE is an aerial UE that is not capable of evaluating whether the UE is inside or outside of the zone, the UE may overwrite the non-aerial UE configuration from SIB-4 with the aerial UE configuration in the container.

As discussed above, a base station may transmit a SIB-4 502 to a UE (e.g., an aerial UE). The SIB-4 502 may include inter-frequency carrier frequency information 504 and a zone indication 508. In an example, the inter-frequency carrier frequency information 504 may correspond to “InterFreqCarrierFreqInfo” as discussed above. The inter-frequency carrier frequency information 504 may include aerial UE cell selection/Reselection criteria 506 for a frequency band. A UE may apply the inter-frequency carrier frequency information 504 for cell selection/reselection purposes when (1) the UE is an aerial UE (based on UE subscription) and (2) the UE is in a zone indicated by the zone indication 508. In an example, the inter-frequency carrier frequency information 504 may include aerial UE specific values for Qᵣₓₗₑᵥₘᵢₙ and/or P_{compensation}. In another example, the inter-frequency carrier frequency information 504 may indicate cell selection/reselection parameters specific for aerial UEs (in addition to the cell selection criterion S described above in (I)-(III)).

The zone indication 508 may indicate a 3D zone of an NTZ. In one example, the zone indication 508 may indicate a polygon with hysteresis, a circle with hysteresis, an ellipse with hysteresis, a closed shape with hysteresis, or a union of closed shapes with hysteresis. In another example, the zone indication 508 may indicate a 2D zone of the NTZ and a height range of the NTZ, where the 2D zone and the height range define the NTZ. In an example, the 2D zone of the NTZ may be represented as a polygon by ((x₁,y₁), . . . (xₙ,yₙ)), where N is a positive integer greater than two. In an example with respect to the height range, a UE may be considered to be in the NTZ if a height of the UE (i.e., a distance of the UE from the ground) is greater than or equal to 100 m and the UE may not be considered to be in the NTZ if the height of the UE is less than 100 m.

The inter-frequency carrier frequency information 504 may include a PCI 510 for a cell for which the aerial UE cell selection/reselection criteria 506 applies.

The inter-frequency carrier frequency information 504 may include UE cell selection/reselection criteria 512. The UE cell selection/reselection criteria 512 may be applied for cell selection/reselection purposes when a UE is not an aerial UE (or when the UE is not operating as an aerial UE). In one example, if a UE that receives the SIB-4 502 is an aerial UE and is operating in a flying state in an NTZ indicated by the zone indication 508, the UE may apply the aerial UE cell selection/reselection criteria 506 for cell selection/reselection. In another example, if a UE that receives the SIB-4 502 is an aerial UE and is not operating in the flying state in the NTZ indicated by the zone indication 508 (or the UE is not located in the NTZ indicated by the zone indication 508), the UE may apply the UE cell selection/reselection criteria 512 for cell selection/reselection. In a further example, if a UE that receives the SIB-4 502 is not an aerial UE, the UE may apply the UE cell selection/reselection criteria 512 for cell selection/reselection. In yet another example, if a UE is not capable of determining whether the UE is an aerial UE, the UE may apply the aerial UE cell selection/reselection criteria 506 for cell selection/reselection.

The inter-frequency carrier frequency information 504 may include a validity time interval 514 for which the aerial UE cell selection/reselection criteria 506 is valid. In an example, the validity time interval 514 may be thirty minutes, one hour, etc. If an aerial UE is located within an NTZ indicated by the zone indication 508 during the validity time interval 514, the aerial UE may apply the aerial UE cell selection/reselection criteria 506 for cell selection/reselection, otherwise, the aerial UE may apply the UE cell selection/reselection criteria 512 for cell selection/reselection.

Applying the aerial UE cell selection/reselection criteria 506 may result in changes to values of Srxlev and/or Sqaul as described above in relation to (I)-(III). The changes to the values of Srxlev and/or Sqaul may result in an aerial UE not transmitting in UL on a frequency band indicated by the SIB-4 502 (or transmitting in UL on the frequency band at a reduced power level). However, the aerial UE cell selection/reselection criteria 506 may not deterministically preclude the UE from transmitting in UL on the frequency band indicated by the SIB-4 502.

In one aspect, SIB-4 may include priority handling information for an aerial UE. For instance, since a UE may have restricted (or zero) UL TX power in an NTZ in a frequency band, the frequency band may be deprioritized during a cell selection/reselection process. Deprioritizing the frequency band may reduce UE power consumption and latency during a cell search. In an example, a network may indicate additional priority for a frequency band in SIB-4 along with an indication of the 3D zone (i.e., zone information). The UE may apply the priority if the UE is an aerial UE operating in a flying state inside an NTZ (i.e., inside the 3D zone). Deletion rules for priority lists maybe specified for aerial UEs. In one example, if the UE is an aerial UE and the UE has obtained a priority for a frequency band from an NTZ-specific extension of a SIB (e.g., a SIB-4) from a past cell, the UE may remember the priority and apply the priority to the frequency band for an NTZ irrespective of new priority configurations received from other SIBs/dedicated signaling. In another example, a network (e.g., a base station) may configure a UE with a priority list during RRCRelease (dedicated signaling). If the UE has obtained an NTZ-specific priority list previously, then the UE may ignore other priorities for the frequency band associated with the NTZ as long as the UE is inside the NTZ.

To address the issue of the aerial UE cell selection/reselection criteria 506 not deterministically precluding the UE from transmitting in UL on the frequency band indicated by the SIB-4 502, the SIB-4 502 may include priority rules 516 for a frequency band in place of or in addition to the aerial UE cell selection/reselection criteria 506. The priority rules 516 may correspond to the priority handling information described above. If the UE is an aerial UE in a flying state in an NTZ indicated by the zone indication 508, the UE may apply the priority rules 516 to deprioritize the frequency band for an UL transmission. In one aspect, the priority rules 516 may deterministically preclude an aerial UE from transmitting in UL on the frequency band indicated by the SIB-4 502.

In one aspect, NTZ-related information may be provided to a UE via an RRC release message 518 (i.e., dedicated signaling). The RRC release message 518 may include the zone indication 508 described above. The RRC release message 518 may also include a deprioritization request 520 for a frequency band associated with a base station in an NTZ indicated by the zone indication 508. The RRC release message 518 may include a cell reselection priority 522. Aspects pertaining to an RRC release message (e.g., the RRC release message 518) are presented below.

RRCRelease-IEs ::= SEQUENCE {
redirectedCarrierInfo RedirectedCarrierInfo OPTIONAL, -- Need N
cellReselectionPriorities CellReselectionPriorities OPTIONAL, -- Need R
suspendConfig SuspendConfig OPTIONAL, -- Need R
deprioritisationReq SEQUENCE {
deprioritisationType ENUMERATED {frequency, nr},
deprioritisationTimer ENUMERATED {min5, min10, min15, min30}
} OPTIONAL, -- Need N
lateNonCriticalExtension OCTET STRING OPTIONAL,
nonCriticalExtension RRCRelease-v1540-IEs OPTIONAL
}

In an example, information elements (IEs) for “cellReselectionPriorities” and “deprioritisationReq” above may be extended to add 3D zone information for aerial UEs.

In one aspect, a UE (e.g., an aerial UE) may receive a configuration/indication pertaining to an NTZ from an upper layer (e.g., an application layer) and the UE may perform various actions based on the configuration/indication. In one example, S-criteria related parameters for a frequency band and an indication of a 2D zone, 2D zone with a height range, or 3D zone may be stored in the UE as a configuration. In another example, if the UE is inside the corresponding zone, the UE may overwrite S-criteria parameters indicated in SIB-4 for the frequency band, e.g., applying or using the S-criteria for aerial UEs instead of the S-criteria for other UEs. In a further example, an aerial UE may have a separate power class configuration (e.g., “config-2”) along with a power class configuration for non-aerial UEs. When the aerial UE is inside of an NTZ (indicated by a network and/or upper layers, e.g., an application layer or flight path information), the aerial UE may switch a power class of the aerial UE from the power class configuration for non-aerial UEs to the separate power class configuration. In yet another example, an aerial UE may overwrite a priority list indicated by a network if the aerial UE receives a priority list from an upper layer and if certain conditions are met (e.g., the UE has an aerial subscription and/or the UE is flying), e.g., the UE may use a priority list for aerial UEs instead of a priority list for other UEs.

A UE (e.g., an aerial UE) may receive an aerial UE indication 524 from an upper layer (e.g., an application layer), where the aerial UE indication 524 may include information similar to the SIB-4 502 and/or the RRC release message 518. The aerial UE indication 524 may correspond to the pre-configuration/indication described above. The aerial UE indication 524 may include the aerial UE cell selection/reselection criteria 506 described above. The UE may store the aerial UE cell selection/reselection criteria 506 as a pre-configuration. The aerial UE indication 524 may also include the zone indication 508 described above. When the UE is inside an NTZ indicated by the zone indication 508 and when the UE is in a flying state, the UE may apply the aerial UE cell selection/reselection criteria 506 for cell selection/reselection. The aerial UE indication 524 may include an aerial UE priority list 526, where the aerial UE priority list 526 may be similar or identical to the priority rules 516. The UE may apply the aerial UE priority list 526 for cell selection/reselection when certain conditions are met (e.g., the UE has an aerial subscription and/or the UE is flying). The aerial UE indication 524 may also include an aerial UE power class configuration 528. When the UE is inside of the NTZ and is operating in a flying state, the UE may apply the aerial UE power class configuration 528.

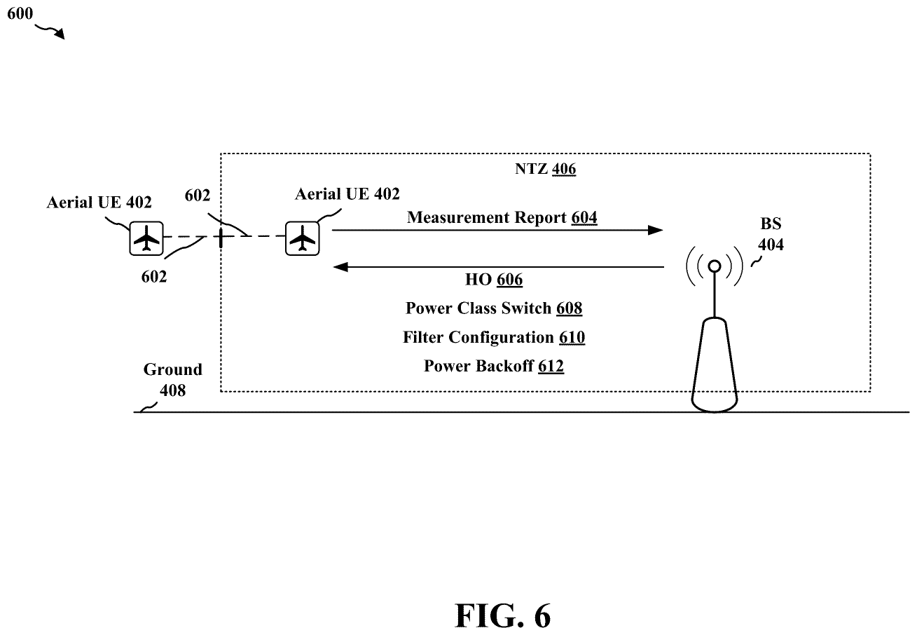

FIG. 6 is a diagram 600 illustrating example aspects of measurement reporting associated with an NTZ. Events may be defined for triggering measurement reports when a UE is in a RRC Connected state. In an example, an event may occur when a UE is inside of a 3D zone (i.e., an NTZ) with hysteresis. A configuration of the 3D zone (e.g., a polygon, a circle, an ellipse, another closed shape, or a union of closed shapes) may be indicated in an report configuration (e.g., a “ReportConfigNR”). Hysteresis in “X” meters may indicate that (1) an entry condition is satisfied when the UE has crossed a boundary of an NTZ and is located at least “X” meters away from the boundary within the NTZ and (2) an exit condition is satisfied when the UE has crossed the boundary of the NTZ and is located at least “X” meters away from boundary outside of the NTZ. The event may trigger a measurement report, that is, the event may cause the UE to transmit a measurement report to a network (e.g., a base station). The UE may report a location of the UE (or a coarse location) of the UE in the measurement report. Based on the measurement report, the network may determine that the UE is inside the NTZ or approaching the NTZ. The network may (1) trigger handover (HO) of the UE to another cell, (2) indicate a power-class switch to the UE, (3) transmit filter configurations, and/or (4) indicate a power backoff for UL transmissions of the UE. The UE may also be configured with a conditional handover which may be triggered by a conditional handover event.

As illustrated in FIG. 6, the aerial UE 402 may be located within the NTZ 406 and the aerial UE 402 may be an RRC Connected state. The aerial UE 402 may determine that the aerial UE 402 is located in the NTZ 406 (or that the aerial UE is approaching the NTZ 406 or that the aerial UE 402 is existing the NTZ 406). For instance, the aerial UE 402 may determine that the aerial UE 402 has crossed a boundary of the NTZ 406 and that the aerial UE 402 is located a threshold distance 602 (i.e., hysteresis in “X” meters) away from the boundary within the NTZ 406 (or that that the aerial UE 402 is located the threshold distance 602 away from the boundary outside of the NTZ 406). Based on the determination, the aerial UE 402 may transmit a measurement report 604 to the base station 404. Based on the measurement report 604, the base station 404 may trigger a HO 606, a power class switch 608, a filter configuration 610, and/or a power backoff 612.

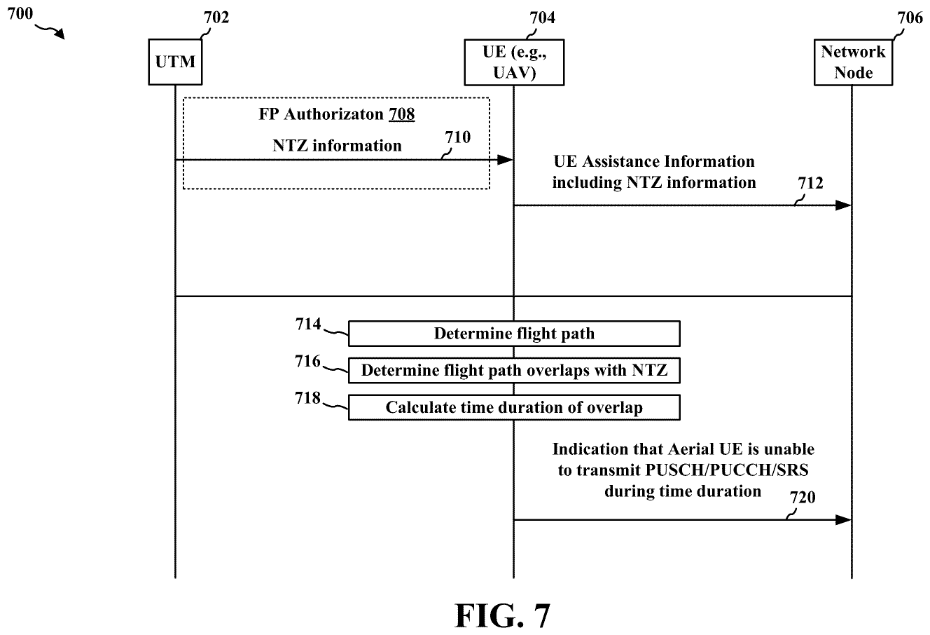

FIG. 7 is a diagram 700 illustrating example aspects of indicating NTZ information. In one aspect, a UE (e.g., an aerial UE) may obtain NTZ information (e.g., an indication of the NTZ, transmission limitations associated with the NTZ, etc.) which a base station currently does not have. In one example, an aerial UE (i.e., a UAV UE) may receive NTZ information from a higher layer and/or from a pre-configuration. For instance, during a flight path authorization, the UE may receive, from an unamend aircraft system traffic management system (UTM), an indication that a flight path (or a part of the flight path) overlaps with an NTZ in a specific band. The UE may indicate the NTZ information in UE assistance information to the base station. In another example, the UE may indicate NTZ information as part of a flight path of the UE. For instance, the UE may indicate to the base station that, for a given time duration (calculated based on the flight path), the UE may be unable to send PUSCH transmissions, PUCCH transmissions, or SRS transmissions.

The diagram 700 depicts a UTM 702, an aerial UE 704, and a network node 706. In one example, at 708, the UTM 702 and the aerial UE 704 may engage in a flight path (FP) authorization. As part of the FP authorization, the UTM 702 may determine that a flight path of the aerial UE 704 overlaps with an NTZ in a frequency band. At 710, the UTM 702 may transmit NTZ information to the aerial UE 704 during the FP authorization. The NTZ information may include an indication of the NTZ and an indication of the frequency band. At 712, the aerial UE 704 may transmit UE assistance information to the network node 706, where the UE assistance information includes the NTZ information.

In another example, at 714, the aerial UE 704 may determine a flight path for a flight of the aerial UE 704. At 716, the aerial UE 704 may determine that the flight path (or a part of the flight path) overlaps with the NTZ. At 718, the aerial UE 704 may calculate a time duration of the overlap, that is, a time duration during which the aerial UE 704 will be within the NTZ during the flight. At 720, the aerial UE 704 may transmit an indication to the network node 706, where the indication indicates that the aerial UE 704 may be unable to transmit PUSCH transmissions, PUCCH transmissions, or SRS transmissions during the time duration.

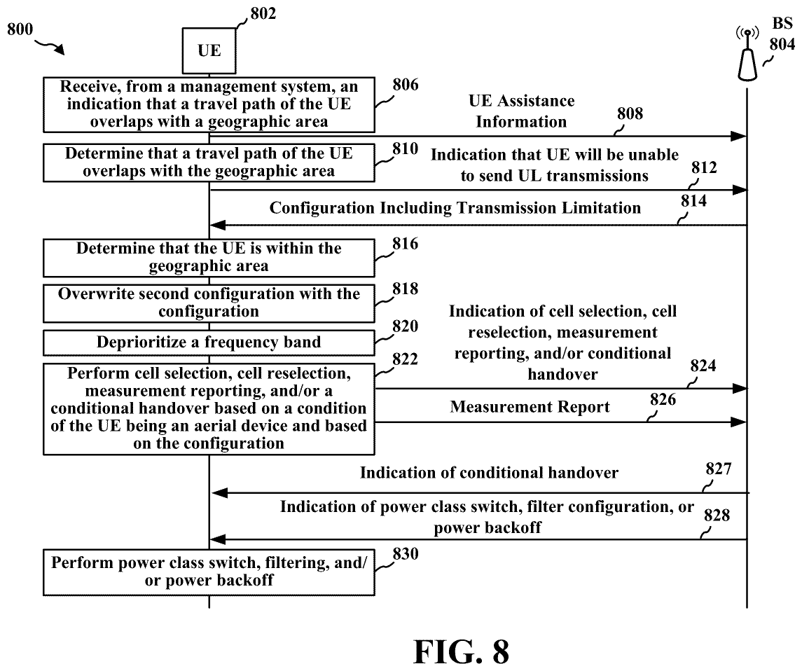

FIG. 8 is a communication flow diagram 800 between a UE 802 and a base station 804. In an example, the UE 802 may be or include the UE 104, the UE 350, the aerial UE 402, the aerial UE 704, or the apparatus 1104. In an example, the base station 804 may be or include the base station 310, the base station 404, the network node 706, the base station 804, the network entity 1102, or the network entity 1202.

At 806, the UE 802 may, from a management system an indication of a travel path of the UE 802 that overlaps with the geographic area. At 808, the UE 802 may transmit, for the base station 804, UE assistance information that includes the indication that the travel path of the UE overlaps with the geographic area. At 810, the UE 802 may determine that a travel path of the UE 802 overlaps with the geographic area. At 812, the UE 802 may transmit, for the network node, an indication that the UE 802 will be unable to send uplink (UL) transmissions on the frequency band during a time period associated with the travel path.

At 814, the UE 802 may receive, from the base station 804, a configuration indicating a transmission limitation for a frequency band for aerial devices within a geographic area. At 816, the UE 802 may determine that the UE 802 is within the geographic area. At 818, the UE 802 may overwrite a second configuration with the configuration based on the determination. At 820, the UE 802 may deprioritize, based on the determination, the frequency band for at least one of the cell selection or the cell reselection. At 822, the UE 802 may perform at least one of cell selection, cell reselection, measurement reporting, or a conditional handover based on a condition of the UE 802 being an aerial device and based on the configuration indicating the transmission limitation. At 824, the base station 804 may receive an indication of at least one of cell selection, cell reselection, measurement reporting, or conditional handover based on a condition of the UE 802 being an aerial device and based on the configuration indicating the transmission limitation.

At 826, the UE 802 may transmit, for the base station 804 and based on the configuration, a measurement report, where the measurement report includes a first indication of a location of the UE. At 827, UE 802 may receive, from the base station 804 and based on the measurement report, a second indication of the conditional handover, where performing the conditional handover may be based on the second indication of the conditional handover. At 828, the UE may receive, from the network node and based on the measurement report, a second indication of a power class switch, a third indication of a filter configuration, or a fourth indication of a power backoff for an uplink (UL) transmission. At 830, the UE 802 may perform at least one of the power class switch, filtering, or the power backoff for the UL transmission based on the second indication, the third indication, or the fourth indication, respectively.

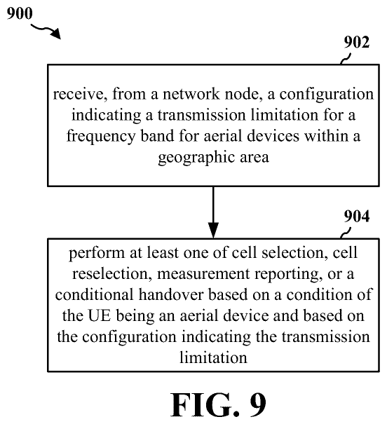

FIG. 9 is a flowchart 900 of a method of wireless communication. The method may be performed by a UE (e.g., the UE 104, the UE 350, the aerial UE 402, the aerial UE 704, the UE 802, the apparatus 1104). The method may be associated with various advantages at the UE, such as reducing and/or mitigating UL transmissions in an NTZ that may cause interference to systems that utilize radio access technologies. In an example, the method (including the various aspects detailed below) may be performed by the aerial UE component 198.

At 902, the UE receives, from a network node, a configuration indicating a transmission limitation for a frequency band for aerial devices within a geographic area. For example, FIG. 8 at 814 shows that the UE 802 may receive, from a network node, a configuration indicating a transmission limitation for a frequency band for aerial devices within a geographic area. In an example, the configuration may be or include the SIB-4 502, the RRC release message 518, and/or the aerial UE indication 524. In an example, the geographic area may be the NTZ 406. In an example, the transmission limitation may be or include the aerial UE cell selection/reselection criteria 506, the priority rules 516, the deprioritization request 520, the cell reselection priority 522, the aerial UE priority list 526, or the aerial UE power class configuration 528. In an example, the network node may be the base station 404. In an example, 902 may be performed by the aerial UE component 198.

At 904, the UE performs at least one of cell selection, cell reselection, measurement reporting, or a conditional handover based on a condition of the UE being an aerial device and based on the configuration indicating the transmission limitation. For example, FIG. 8 at 822 shows that the UE 802 may perform at least one of cell selection, cell reselection, measurement reporting, or a conditional handover based on the UE being an aerial device and based on the configuration indicating the transmission limitation. In an example, 904 may be performed by the aerial UE component 198.

In one aspect, the transmission limitation may include an indication to not transmit in the frequency band when the UE is within the geographic area and when the UE is the aerial device. For example, the transmission limitation in the configuration may indicate that the UE is not transmit in the frequency band when the UE is within the NTZ 406 and when the UE is the aerial UE 402.

In one aspect, the transmission limitation may include a transmission power limit for transmissions in the frequency band when the UE is within the geographic area and when the UE is the aerial device. For example, the transmission power limit may be indicated by the aerial UE cell selection/reselection criteria 506.

In one aspect, the condition of the UE being the aerial device may be based on at least one of: the UE being in an aerial state or at a position above a height threshold, or the UE having an aerial subscription. For example, FIG. 4A shows that the condition of the UE being the aerial device may be based on at least one of: the UE being in an aerial state or at a position above a height threshold, or the UE having an aerial subscription.

In one aspect, the geographic area may include a zone associated with the transmission limitation. For example, the zone may be the NTZ 406.

In one aspect, the zone may be indicated in the configuration as one of: a three-dimensional (3D) zone, or a two-dimensional (2D) zone and a height range. For example, the zone indication 508 in FIG. 5 may indicate the zone as one of a three-dimensional (3D) zone, or a two-dimensional (2D) zone and a height range.

In one aspect, the UE may determine that the UE is within the geographic area, where performing at least one of the cell selection, the cell reselection, the measurement reporting, or the conditional handover may be further based on the UE being within the geographic area. For example, FIG. 8 shows that the UE 802 may determine that the UE 802 is within the geographic area, where performing at least one of the cell selection, the cell reselection, the measurement reporting, or the conditional handover may be further based on the UE being within the geographic area.

In one aspect, the configuration may be included in a system information block type (SIB), where the SIB further may include a second configuration for at least one of the cell selection or the cell reselection, and the UE may overwrite the second configuration with the configuration based on the determination. For example, FIG. 5 shows that the configuration may be included in the SIB-4 502. In another example, the second configuration for at least one of the cell selection or the cell reselection may be the UE cell selection/reselection criteria 512. In a further example, FIG. 8 at 818 shows that the UE 802 may overwrite the second configuration with the configuration based on the determination.

In one aspect, the SIB may include a system information block type 4 (SIB-4). For example, the SIB-4 may be the SIB-4 502.

In one aspect, the transmission limitation may indicate that the UE is to deprioritize the frequency band for at least one the cell selection or the cell reselection when the UE is the aerial device and when the UE is within the geographic area, and the UE may deprioritize, based on the determination, the frequency band for at least one of the cell selection or the cell reselection. For example, the priority rules 516 may correspond to the transmission limitation indicating that the UE is to deprioritize the frequency band for at least one the cell selection or the cell reselection when the UE is the aerial device and when the UE is within the geographic area. In another example, FIG. 8 at 820 shows that the UE 802 may deprioritize, based on the determination, the frequency band for at least one of the cell selection or the cell reselection.

In one aspect, performing the measurement reporting may include transmitting, for the network node and based on the configuration, a measurement report, where the measurement report may include a first indication of a location of the UE. For example, FIG. 8 at 826 shows that the UE 802 may transmit, for the network node and based on the configuration, a measurement report, where the measurement report may include a first indication of a location of the UE 802. In another example, FIG. 6 shows that the aerial UE 402 may transmit the measurement report 604.

In one aspect, the UE may receive, from the network node and based on the measurement report, a second indication of the conditional handover, where performing the conditional handover may be based on the second indication of the conditional handover. For example, FIG. 8 at 827 shows that the UE 802 may receive, from the network node and based on the measurement report, a second indication of the conditional handover, where performing the conditional handover may be based on the second indication of the conditional handover. In another example, FIG. 6 shows that the aerial UE 402 may receive an indication of the HO 606.

In one aspect, the UE may receive, from the network node and based on the measurement report, a second indication of a power class switch, a third indication of a filter configuration, or a fourth indication of a power backoff for an uplink (UL) transmission. For example, FIG. 8 at 828 shows that the UE 802 may receive, from the network node and based on the measurement report, a second indication of a power class switch, a third indication of a filter configuration, or a fourth indication of a power backoff for an uplink (UL) transmission. In another example, FIG. 6 shows that the aerial UE 402 may receive the power class switch 608, the indication of the filter configuration 610, or the indication of the power backoff 612.

In one aspect, the UE may perform at least one of the power class switch, filtering, or the power backoff for the UL transmission based on the second indication, the third indication, or the fourth indication, respectively. For example, FIG. 8 at 830 shows that the UE 802 may perform at least one of the power class switch, filtering, or the power backoff for the UL transmission based on the second indication, the third indication, or the fourth indication, respectively.

In one aspect, determining whether the UE is within the geographic area may include determining whether the UE has entered the geographic area or whether the UE has exited the geographic area, where determining whether the UE has entered the geographic area may include determining that the UE has crossed a boundary of the geographic area and is located at least a threshold distance away from the boundary within the geographic area, and where determining whether the UE has exited the geographic area may include determining that the UE has crossed the boundary of the geographic area and is located at least the threshold distance away from the boundary outside of the geographic area. For example, determining whether the UE is within the geographic area at 816 may include determining whether the UE has entered the geographic area or whether the UE has exited the geographic area, where determining whether the UE has entered the geographic area may include determining that the UE has crossed a boundary of the geographic area and is located at least a threshold distance away from the boundary within the geographic area, and where determining whether the UE has exited the geographic area may include determining that the UE has crossed the boundary of the geographic area and is located at least the threshold distance away from the boundary outside of the geographic area. In another example, the aforementioned aspect may correspond to FIG. 6.

In one aspect, the configuration may be included in a radio resource control release (RRC) message, and where the configuration further may indicate a deprioritization request or a cell reselection priority. For example, FIG. 5 shows that the configuration may be included in the RRC release message 518. Furthermore, FIG. 5 shows that the RRC release message 518 may include the deprioritization request 520 or the cell reselection priority 522.

In one aspect, the UE may be in a radio resource control (RRC) inactive state or a RRC active state when the configuration is received. For example, the UE 802 may be in a RRC inactive state or a RRC active state when the configuration is received at 814.

In one aspect, the configuration may be received via an upper layer. For example, the upper layer may be an application layer. In an example, the aforementioned aspect may correspond to the aerial UE indication 524.

In one aspect, the configuration may further indicate a time period for which the configuration is valid, and where performing at least one of the cell selection, the cell reselection, the measurement reporting, or the conditional handover may occur during the time period. For example, the aforementioned aspect may correspond to the validity time interval 514 of FIG. 5.

In one aspect, the UE may receive, from a management system an indication of a travel path of the UE that overlaps with the geographic area. For example, FIG. 8 at 806 shows that the UE 802 may receive, from a management system an indication of a travel path of the UE that overlaps with the geographic area. In another example, FIG. 7 at 710 shows that the aerial UE 704 may receive, from the UTM 702, an indication of a travel path of the UE that overlaps with the geographic area.

In one aspect, the UE may transmit, for the network node, UE assistance information that may include the indication that the travel path of the UE overlaps with the geographic area, where receiving the configuration may be further based on the UE assistance information. For example, FIG. 8 at 808 shows that the UE 802 may transmit, for the network node, UE assistance information that may include the indication that the travel path of the UE overlaps with the geographic area, where receiving the configuration may be further based on the UE assistance information. In another example, FIG. 7 at 712 shows that the aerial UE 704 may transmit, for the network node, UE assistance information that may include the indication that the travel path of the UE overlaps with the geographic area, where receiving the configuration may be further based on the UE assistance information.

In one aspect, the UE may determine that a travel path of the UE overlaps with the geographic area. For example, FIG. 8 at 810 shows that the UE 802 may determine that a travel path of the UE 802 overlaps with the geographic area. In another example, FIG. 7 at 716 shows that the aerial UE 704 may determine that a travel path of the UE overlaps with the geographic area.

In one aspect, the UE may transmit, for the network node, an indication that the UE will be unable to send uplink (UL) transmissions on the frequency band during a time period associated with the travel path. For example, FIG. 8 at 812 shows that the UE 802 may transmit, for the network node, an indication that the UE will be unable to send uplink (UL) transmissions on the frequency band during a time period associated with the travel path. In another example, FIG. 7 at 720 shows that the aerial UE 704 may transmit, for the network node, an indication that the UE will be unable to send uplink (UL) transmissions on the frequency band during a time period associated with the travel path.

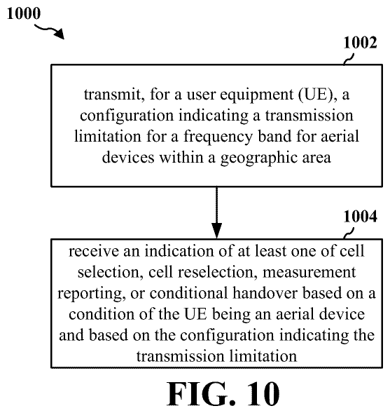

FIG. 10 is a flowchart 1000 of a method of wireless communication. The method may be performed by a network node (e.g., the base station 102, the base station 310, the base station 404, the network node 706, the base station 804, the network entity 1102, the network entity 1202). The method may be associated with various advantages at the network node, such as reducing and/or mitigating UL transmissions in an NTZ that may cause interference to systems that utilize radio access technologies. In an example, the method (including the various aspects detailed below) may be performed by the aerial UE component 199.

At 1002, the network node transmits, for a user equipment (UE), a configuration indicating a transmission limitation for a frequency band for aerial devices within a geographic area. For example, FIG. 8 at 814 shows that the base station 804 may transmit, for the UE 802, a configuration indicating a transmission limitation for a frequency band for aerial devices within a geographic area. In an example, the configuration may be or include the SIB-4 502, the RRC release message 518, and/or the aerial UE indication 524. In an example, the geographic area may be the NTZ 406. In an example, the transmission limitation may be or include the aerial UE cell selection/reselection criteria 506, the priority rules 516, the deprioritization request 520, the cell reselection priority 522, the aerial UE priority list 526, or the aerial UE power class configuration 528. In an example, 1002 may be performed by the aerial UE component 199.

At 1004, the network node receives an indication of at least one of cell selection, cell reselection, measurement reporting, or conditional handover based on a condition of the UE being an aerial device and based on the configuration indicating the transmission limitation. For example, FIG. 8 at 824 shows that the base station 804 may receive an indication of at least one of cell selection, cell reselection, measurement reporting, or conditional handover based on a condition of the UE being an aerial device and based on the configuration indicating the transmission limitation. In an example, 1004 may be performed by the aerial UE component 199.

In one aspect, the transmission limitation may include a first indication to not transmit in the frequency band when the UE is within the geographic area and when the UE is the aerial device. For example, the transmission limitation in the configuration may indicate that the UE is not transmit in the frequency band when the UE is within the NTZ 406 and when the UE is the aerial UE 402.

In one aspect, the transmission limitation may include a transmission power limit for transmissions in the frequency band when the UE is within the geographic area and when the UE is the aerial device. For example, the transmission power limit may be indicated by the aerial UE cell selection/reselection criteria 506.

In one aspect, the condition of the UE being the aerial device may include at least one of: the UE being in a flying state, or the UE having an aerial subscription. For example, FIG. 4A shows that the condition of the UE being the aerial device may be based on at least one of: the UE being in an aerial state or at a position above a height threshold, or the UE having an aerial subscription.

In one aspect, the geographic area may include a zone associated with the transmission limitation. For example, the zone may be the NTZ 406.

In one aspect, the zone may be indicated in the configuration as one of: a three-dimensional (3D) zone, or a two-dimensional (2D) zone and a height range. For example, the zone indication 508 in FIG. 5 may indicate the zone as one of a three-dimensional (3D) zone, or a two-dimensional (2D) zone and a height range.

In one aspect, the configuration may be included in a system information block SIB-4, where the SIB further may include a second configuration for at least one of the cell selection or the cell reselection. For example, FIG. 5 shows that the configuration may be included in the SIB-4 502. In another example, the second configuration for at least one of the cell selection or the cell reselection may be the UE cell selection/reselection criteria 512.

In one aspect, the SIB may include a system information block type 4 (SIB-4). For example, the SIB-4 may be the SIB-4 502.

In one aspect, the transmission limitation may indicate that the UE is to deprioritize the frequency band for at least one the cell selection or the cell reselection when the UE is the aerial device and when the UE is within the geographic area. For example, the priority rules 516 may correspond to the transmission limitation indicating that the UE is to deprioritize the frequency band for at least one the cell selection or the cell reselection when the UE is the aerial device and when the UE is within the geographic area.

In one aspect, receiving the indication of at least one of the cell selection, the cell reselection, the measurement reporting, or the conditional handover may include receiving, from the UE, a measurement report, where the measurement report may include a first indication of a location of the UE. For example, FIG. 8 at 826 shows that the base station 804 may receive, from the UE 802, a measurement report, where the measurement report may include a first indication of a location of the UE 802.

In one aspect, the network node may transmit, for the UE and based on the measurement report, a second indication of the conditional handover. For example, FIG. 8 at 827 shows that the base station 804 may transmit, for the UE and based on the measurement report, a second indication of the conditional handover.

In one aspect, the network node may transmit, for the UE and based on the measurement report, a second indication of a power class switch, a third indication of a filter configuration, or a fourth indication of a power backoff for an uplink (UL) transmission. For example, FIG. 8 at 828 shows that the base station 804 may transmit, for the UE and based on the measurement report, a second indication of a power class switch, a third indication of a filter configuration, or a fourth indication of a power backoff for an uplink (UL) transmission. In another example, FIG. 6 shows that the base station may transmit an indication of a power class switch 608, an indication of a filter configuration 610, or an indication of a power backoff 612.

In one aspect, the configuration may be included in a radio resource control release (RRC) message, and where the configuration may further indicate a deprioritization request or a cell reselection priority. For example, FIG. 5 shows that the configuration may be included in the RRC release message 518. Furthermore, FIG. 5 shows that the RRC release message 518 may include the deprioritization request 520 or the cell reselection priority 522.

In one aspect, the configuration may be transmitted via an upper layer. For example, the upper layer may be an application layer. In an example, the aforementioned aspect may correspond to the aerial UE indication 524.

In one aspect, the configuration further may indicate a time period for which the configuration is valid, and where receiving the indication of at least one of the cell selection, the cell reselection, the measurement reporting, or the conditional handover may occur during the time period. For example, the aforementioned aspect may correspond to the validity time interval 514 of FIG. 5.

In one aspect, the network node may receive, from the UE, UE assistance information that includes a first indication that a travel path of the UE overlaps with the geographic area, where transmitting the configuration may be further based on the UE assistance information. For example, FIG. 8 at 808 shows that the base station 804 may receive, from the UE 802, UE assistance information that may include a first indication that a travel path of the UE overlaps with the geographic area, where transmitting the configuration may be further based on the UE assistance information. In another example, FIG. 7 at 712 shows that the network node 706 may receive, from the aerial UE 704, UE assistance information that may include the indication that the travel path of the UE overlaps with the geographic area, where transmitting the configuration may be further based on the UE assistance information.

In one aspect, the network node may receive, from the UE, a first indication that the UE will be unable to send uplink (UL) transmissions during a time period associated with a travel path of the UE, where the travel path may overlap with the geographic area. For example, FIG. 8 at 812 shows that the base station 804 may receive, from the UE, a first indication that the UE 802 will be unable to send uplink (UL) transmissions during a time period associated with a travel path of the UE, where the travel path may overlap with the geographic area. In another example, FIG. 7 at 720 shows that the network node 706 may receive, from the UE, a first indication that the UE will be unable to send uplink (UL) transmissions during a time period associated with a travel path of the UE, where the travel path may overlap with the geographic area.

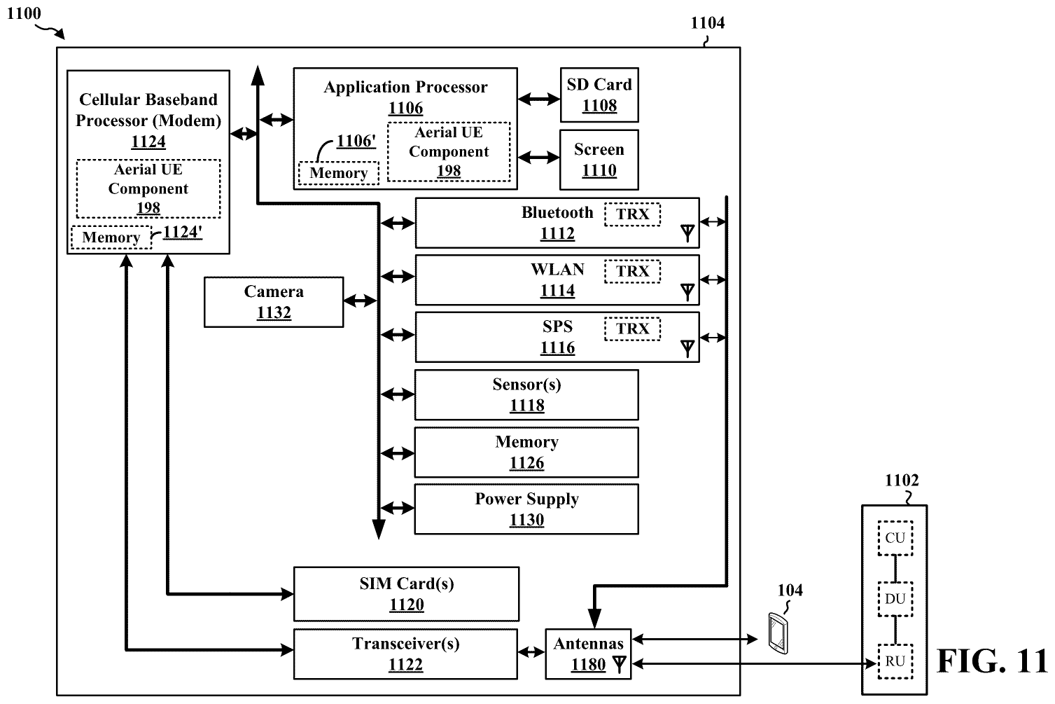

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

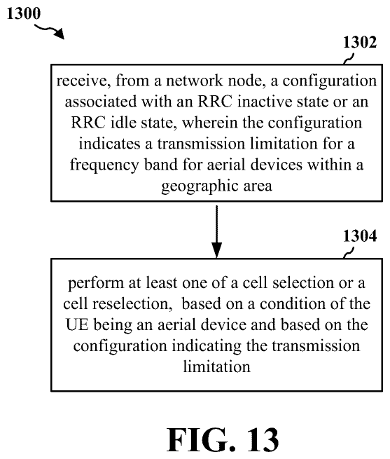

As discussed supra, the aerial UE component 198 may be configured to receive, from a network node, a configuration indicating a transmission limitation for a frequency band for aerial devices within a geographic area. The aerial UE component 198 may be configured to perform at least one of cell selection, cell reselection, measurement reporting, or a conditional handover based on a condition of the UE being an aerial device and based on the configuration indicating the transmission limitation. The aerial UE component 198 may be configured to determine that the UE is within the geographic area, where performing at least one of the cell selection, the cell reselection, the measurement reporting, or the conditional handover is further based on the UE being within the geographic area. The aerial UE component 198 may be configured to overwrite the second configuration with the configuration based on the determination. The aerial UE component 198 may be configured to deprioritize, based on the determination, the frequency band for at least one of the cell selection or the cell reselection. The aerial UE component 198 may be configured to receive, from the network node and based on the measurement report, a second indication of the conditional handover, where performing the conditional handover is based on the second indication of the conditional handover. The aerial UE component 198 may be configured to receive, from the network node and based on the measurement report, a second indication of a power class switch, a third indication of a filter configuration, or a fourth indication of a power backoff for an uplink (UL) transmission. The aerial UE component 198 may be configured to perform at least one of the power class switch, filtering, or the power backoff for the UL transmission based on the second indication, the third indication, or the fourth indication, respectively. The aerial UE component 198 may be configured to receive, from a management system an indication of a travel path of the UE that overlaps with the geographic area. The aerial UE component 198 may be configured to transmit, for the network node, UE assistance information that includes the indication that the travel path of the UE overlaps with the geographic area, where receiving the configuration is further based on the UE assistance information. The aerial UE component 198 may be configured to determine that a travel path of the UE overlaps with the geographic area. The aerial UE component 198 may be configured to transmit, for the network node, an indication that the UE will be unable to send uplink (UL) transmissions on the frequency band during a time period associated with the travel path. The aerial UE component 198, and/or the apparatus 1104, may be configured to perform any of the aspects described in connection with the flowcharts in any of FIGS. 9, 13, and/or 15, or aspects performed by the UE in the communication flow in FIG. 8. The aerial UE component 198 may be within the cellular baseband processor 1124, the application processor 1106, or both the cellular baseband processor 1124 and the application processor 1106. The aerial UE component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor 1124 and/or the application processor 1106, may include means for receiving, from a network node, a configuration indicating a transmission limitation for a frequency band for aerial devices within a geographic area. In one configuration, the apparatus 1104, and in particular the cellular baseband processor 1124 and/or the application processor 1106, may include means for performing at least one of cell selection, cell reselection, measurement reporting, or a conditional handover based on a condition of the UE being an aerial device and based on the configuration indicating the transmission limitation. In one configuration, the apparatus 1104, and in particular the cellular baseband processor 1124 and/or the application processor 1106, may include means for determining that the UE is within the geographic area, where performing at least one of the cell selection, the cell reselection, the measurement reporting, or the conditional handover is further based on the UE being within the geographic area. In one configuration, the apparatus 1104, and in particular the cellular baseband processor 1124 and/or the application processor 1106, may include means for overwriting the second configuration with the configuration based on the determination. In one configuration, the apparatus 1104, and in particular the cellular baseband processor 1124 and/or the application processor 1106, may include means for deprioritizing, based on the determination, the frequency band for at least one of the cell selection or the cell reselection. In one configuration, the apparatus 1104, and in particular the cellular baseband processor 1124 and/or the application processor 1106, may include means for receiving, from the network node and based on the measurement report, a second indication of the conditional handover, where performing the conditional handover is based on the second indication of the conditional handover. In one configuration, the apparatus 1104, and in particular the cellular baseband processor 1124 and/or the application processor 1106, may include means for receiving, from the network node and based on the measurement report, a second indication of a power class switch, a third indication of a filter configuration, or a fourth indication of a power backoff for an uplink (UL) transmission. In one configuration, the apparatus 1104, and in particular the cellular baseband processor 1124 and/or the application processor 1106, may include means for performing at least one of the power class switch, filtering, or the power backoff for the UL transmission based on the second indication, the third indication, or the fourth indication, respectively. In one configuration, the apparatus 1104, and in particular the cellular baseband processor 1124 and/or the application processor 1106, may include means for receiving, from a management system an indication of a travel path of the UE that overlaps with the geographic area. In one configuration, the apparatus 1104, and in particular the cellular baseband processor 1124 and/or the application processor 1106, may include means for transmitting, for the network node, UE assistance information that includes the indication that the travel path of the UE overlaps with the geographic area, where receiving the configuration is further based on the UE assistance information. In one configuration, the apparatus 1104, and in particular the cellular baseband processor 1124 and/or the application processor 1106, may include means for determining that a travel path of the UE overlaps with the geographic area. In one configuration, the apparatus 1104, and in particular the cellular baseband processor 1124 and/or the application processor 1106, may include means for transmitting, for the network node, an indication that the UE will be unable to send uplink (UL) transmissions on the frequency band during a time period associated with the travel path. The apparatus 1104 may include means for performing any of the aspects described in connection with the flowcharts in any of FIGS. 9, 13, and/or 15, or aspects performed by the UE in the communication flow in FIG. 8. The means may be the aerial UE component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

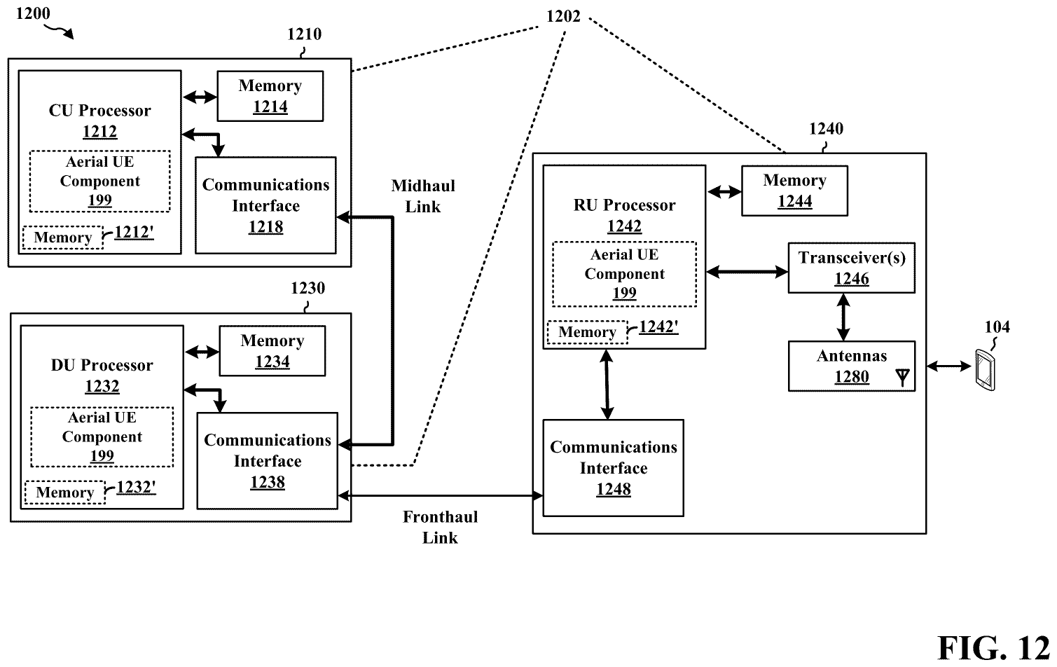

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the aerial UE component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

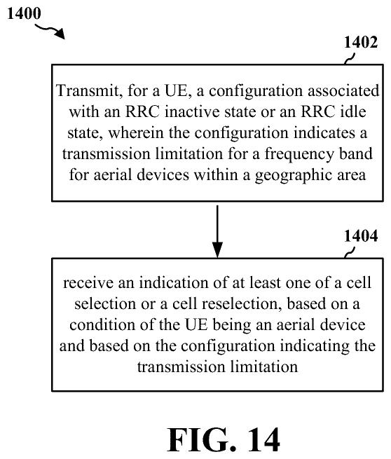

As discussed supra, the aerial UE component 199 may be configured to transmit, for a user equipment (UE), a configuration indicating a transmission limitation for a frequency band for aerial devices within a geographic area. The aerial UE component 199 may be configured to receive an indication of at least one of cell selection, cell reselection, measurement reporting, or conditional handover based on a condition of the UE being an aerial device and based on the configuration indicating the transmission limitation. The aerial UE component 199 may be configured to transmit, for the UE and based on the measurement report, a second indication of the conditional handover. The aerial UE component 199 may be configured to transmit, for the UE and based on the measurement report, a second indication of a power class switch, a third indication of a filter configuration, or a fourth indication of a power backoff for an uplink (UL) transmission. The aerial UE component 199 may be configured to receive, from the UE, UE assistance information that includes a first indication that a travel path of the UE overlaps with the geographic area, where transmitting the configuration is further based on the UE assistance information. The aerial UE component 199 may be configured to receive, from the UE, a first indication that the UE will be unable to send uplink (UL) transmissions during a time period associated with a travel path of the UE, where the travel path overlaps with the geographic area. The aerial UE component 199, or the network entity 1202, may be configured to perform any of the aspects described in connection with the flowcharts in any of FIGS. 10, 14, and/or 16, or aspects performed by the network node in the communication flow in FIG. 7 or 8. The aerial UE component 199 may be within one or more processors of one or more of the CU 1210, DU 1230, and the RU 1240. The aerial UE component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting, for a user equipment (UE), a configuration indicating a transmission limitation for a frequency band for aerial devices within a geographic area. In one configuration, the network entity 1202 may include means for receiving an indication of at least one of cell selection, cell reselection, measurement reporting, or conditional handover based on a condition of the UE being an aerial device and based on the configuration indicating the transmission limitation. In one configuration, the network entity 1202 may include means for transmitting, for the UE and based on the measurement report, a second indication of the conditional handover. In one configuration, the network entity 1202 may include means for transmitting, for the UE and based on the measurement report, a second indication of a power class switch, a third indication of a filter configuration, or a fourth indication of a power backoff for an uplink (UL) transmission. In one configuration, the network entity 1202 may include means for receiving, from the UE, UE assistance information that includes a first indication that a travel path of the UE overlaps with the geographic area, where transmitting the configuration is further based on the UE assistance information. In one configuration, the network entity 1202 may include means for receiving, from the UE, a first indication that the UE will be unable to send uplink (UL) transmissions during a time period associated with a travel path of the UE, where the travel path overlaps with the geographic area. The network entity 1202 may include means for performing any of the aspects described in connection with the flowcharts in any of FIGS. 10, 14, and/or 16, or aspects performed by the network node in the communication flow in FIG. 7 or 8. The means may be the aerial UE component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 13 is a flowchart 1300 of a method of wireless communication. The method may be performed by a UE (e.g., the UE 104, the UE 350, the aerial UE 402, the aerial UE 704, the UE 802, the apparatus 1104). The method may be associated with various advantages at the UE, such as reducing and/or mitigating UL transmissions in an NTZ that may cause interference to systems that utilize radio access technologies. In an example, the method (including the various aspects detailed below) may be performed by the aerial UE component 198.

At 1302, the UE receives, from a network node, a configuration associated with an RRC inactive state or an RRC idle state, wherein the configuration indicates a transmission limitation for a frequency band for aerial devices within a geographic area. For example, FIG. 8 at 814 shows that the UE 802 may receive, from a network node, a configuration indicating a transmission limitation for a frequency band for aerial devices within a geographic area. In some aspects, the transmission limitation includes an indication to not transmit in the frequency band when the UE is within the geographic area and when the UE is the aerial device. In some aspects, the transmission limitation includes a transmission power limit for transmissions in the frequency band when the UE is within the geographic area and when the UE is the aerial device. In some aspects, the geographic area comprises a zone associated with the transmission limitation. For example, the zone may be the NTZ 406. In some aspects, the zone may be indicated in the configuration as one of a three-dimensional (3D) zone, or a two-dimensional (2D) zone and a height range. In some aspects, the configuration is included in a SIB, e.g., a SIB-4. In an example, 1302 may be performed by the aerial UE component 198.

At 1304, the UE performs at least one of a cell selection or a cell reselection, based on a condition of the UE being an aerial device and based on the configuration indicating the transmission limitation. For example, FIG. 8 at 822 shows that the UE 802 may perform at least one of cell selection or cell reselection based on the UE being an aerial device and based on the configuration indicating the transmission limitation. In some aspects, the condition of the UE being the aerial device is based on at least one of the UE being in an aerial state or at a position above a height threshold, or the UE having an aerial subscription. For example, FIG. 4A shows that the condition of the UE being the aerial device may be based on at least one of: the UE being in an aerial state or at a position above a height threshold, or the UE having an aerial subscription. In an example, 1304 may be performed by the aerial UE component 198.

In some aspects, the UE may determine that the UE is within the geographic area, and perform at least one of the cell selection or the cell reselection according to the configuration, at 1304, based on the UE being within the geographic area. For example, FIG. 8 shows that the UE 802 may determine that the UE 802 is within the geographic area, and performing cell selection/reselection based on the determination.

In some aspects, the configuration is a configuration included in a SIB (e.g., which may be referred to as a first configuration), and the SIB further includes an addition configuration (e.g., which may be referred to as a second configuration) for the at least one of the cell selection or the cell reselection. For example, FIG. 5 shows that the configuration may be included in the SIB-4 502. The UE may apply the first configuration and not the second configuration based on a determination that the UE is within the geographic area. In an example, FIG. 8 at 818 shows that the UE 802 may overwrite the second configuration with the configuration based on the determination.

In some aspects, the transmission limitation indicates that the UE is to deprioritize the frequency band for the at least one of the cell selection or the cell reselection when the UE is the aerial device and when the UE is within the geographic area, the UE deprioritizes, based on a determination that the UE is within the geographic area, the frequency band for at least one of the cell selection or the cell reselection.

In some aspects, the UE may switch to a different power class configuration based on the UE being within the geographic area. In some aspects, the configuration may be included in an RRC release message, and wherein the configuration further indicates a deprioritization request or a cell reselection priority. FIG. 8 at 820 shows that the UE 802 may deprioritize, based on the determination, the frequency band for at least one of the cell selection or the cell reselection.

FIG. 14 is a flowchart 1400 of a method of wireless communication. The method may be performed by a network node (e.g., the base station 102, the base station 310, the base station 404, the network node 706, the base station 804, the network entity 1102, the network entity 1202). The method may be associated with various advantages at the network node, such as reducing and/or mitigating UL transmissions in an NTZ that may cause interference to systems that utilize radio access technologies. In an example, the method (including the various aspects detailed below) may be performed by the aerial UE component 199.

At 1402, the network node transmits, for a UE, a configuration associated with an RRC inactive state or an RRC idle state, wherein the configuration indicates a transmission limitation for a frequency band for aerial devices within a geographic area. FIG. 8 illustrates an example of a network node providing a configuration to a UE. In some aspects, the transmission limitation includes a first indication to not transmit in the frequency band when the UE is within the geographic area and when the UE is the aerial device. In some aspects, the transmission limitation includes a transmission power limit for transmissions in the frequency band when the UE is within the geographic area and when the UE is the aerial device. In some aspects, the geographic area comprises a zone associated with the transmission limitation. In some aspects, the zone is indicated in the configuration as one of: a three-dimensional (3D) zone, or a two-dimensional (2D) zone and a height range. FIGS. 4A, 4B, and 6 illustrate examples of geographic locations. In an example, 1402 may be performed by the aerial UE component 199.

At 1404, the network node receives an indication of at least one of a cell selection or a cell reselection, based on a condition of the UE being an aerial device and based on the configuration indicating the transmission limitation. FIG. 8 illustrates an example of a network node receiving an indication of the cell selection or reselection. In some aspects, the condition of the UE being the aerial device is based on at least one of: the UE being in an aerial state or at a position above a height threshold, or the UE having an aerial subscription. In an example, 1404 may be performed by the aerial UE component 199.

In some aspects, the configuration is included in a system information block (SIB), where the SIB further includes a second configuration for at least one of the cell selection or the cell reselection.

In some aspects, the transmission limitation indicates that the UE is to deprioritize the frequency band for at least one the cell selection or the cell reselection when the UE is the aerial device and when the UE is within the geographic area.

In some aspects, the configuration is included in an RRC message, and wherein the configuration further indicates a deprioritization request or a cell reselection priority.

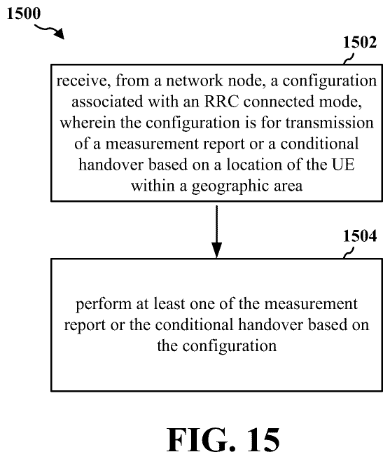

FIG. 15 is a flowchart 1500 of a method of wireless communication. The method may be performed by a UE (e.g., the UE 104, the UE 350, the aerial UE 402, the aerial UE 704, the UE 802, the apparatus 1104). The method may be associated with various advantages at the UE, such as reducing and/or mitigating UL transmissions in an NTZ that may cause interference to systems that utilize radio access technologies. In an example, the method (including the various aspects detailed below) may be performed by the aerial UE component 198.

At 1502, the UE receives, from a network node, a configuration associated with an RRC connected state or an RRC idle state, wherein the configuration is for transmission of a measurement report or a conditional handover based on a location of the UE within a geographic area. For example, FIG. 8 at 814 shows that the UE 802 may receive, from a network node, a configuration for devices within a geographic area. In some aspects, the configuration is included in a SIB, e.g., a SIB-4. In some aspects, the configuration may be received via an upper layer. In an example, 1502 may be performed by the aerial UE component 198.

In some aspects, the geographic area may be associated with a transmission limitation for a frequency band. In some aspects, the transmission limitation includes an indication to not transmit in the frequency band when the UE is within the geographic area and when the UE is the aerial device. In some aspects, the transmission limitation includes a transmission power limit for transmissions in the frequency band when the UE is within the geographic area and when the UE is the aerial device. In some aspects, the geographic area comprises a zone associated with the transmission limitation. For example, the zone may be the NTZ 406. In some aspects, the zone may be indicated in the configuration as one of a three-dimensional (3D) zone, or a two-dimensional (2D) zone and a height range.

At 1504, the UE performs at least one of the measurement report or the conditional handover based on the configuration. For example, FIG. 8 at 822 shows that the UE 802 may perform measurement report or conditional handover based on the configuration. In an example, 1504 may be performed by the aerial UE component 198.

some aspects, the configuration is based on the location of the UE within the geographic area and further based on a hysteresis condition. As an example, the hysteresis condition is based at least one of: entry into the geographic area and at least a first number of meters inside a boundary of the geographic area, or exit from the geographic area and at least a second number of meters outside the boundary of the geographic area.

In some aspects, at 1504, the UE may transmit, for the network node and based on the configuration, the measurement report, wherein the measurement report includes a first indication of the location of the UE. FIG. 6 and FIG. 8 illustrate examples of a UE providing a measurement report.

In some aspects, the UE may receive, from the network node and based on the measurement report, a second indication of the conditional handover, wherein to perform the conditional handover, the at least one processor is configured to perform the conditional handover based on the second indication of the conditional handover. FIG. 6 illustrates an example of a UE receiving an indication of a handover in response to a measurement report.

In some aspects, the UE may receive, from the network node and based on the measurement report, a second indication of one or more of a power class switch, a filter configuration, or a power backoff for an uplink (UL) transmission; and perform at least one of the power class switch, filtering, or the power backoff for the UL transmission based on the second indication. FIG. 6 illustrates an example of a UE receiving such information in response to a measurement report.

In some aspects, the configuration further indicates a time period for which the configuration is valid, and wherein performance of the at least one of measurement reporting or the conditional handover is conditional to be performed during the time period indicted for the configuration.

In some aspects, the UE may receive, from a management system an indication of a travel path of the UE that overlaps with the geographic area; and transmit, for the network node, UE assistance information that includes the indication that the travel path of the UE overlaps with the geographic area, wherein the configuration is based on the UE assistance information. FIG. 7 illustrates an example of a UE providing UE assistance information, at 712.

In some aspects, the transmission limitation is associated with the geographic location, and the UE may determine that a travel path of the UE overlaps with the geographic area; and transmit, for the network node, an indication that the UE will be unable to send uplink (UL) transmissions on a frequency band during a time period associated with the travel path. FIG. 7 illustrates an example of a UE providing an indication, at 720.

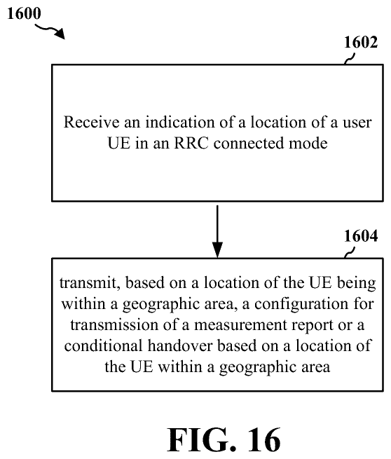

FIG. 16 is a flowchart 1600 of a method of wireless communication. The method may be performed by a network node (e.g., the base station 102, the base station 310, the base station 404, the network node 706, the base station 804, the network entity 1102, the network entity 1202). The method may be associated with various advantages at the network node, such as reducing and/or mitigating UL transmissions in an NTZ that may cause interference to systems that utilize radio access technologies. In an example, the method (including the various aspects detailed below) may be performed by the aerial UE component 199.

At 1602, the network node receives an indication of a location of a UE in an RRC connected mode. In some aspects, the network node receives, from the UE, a measurement report, wherein the measurement report that indicates the location of the UE. FIG. 6 and FIG. 8 illustrate examples of a UE providing a measurement report. In some aspects, the network node receives, from the UE, UE assistance information that includes a first indication that a travel path of the UE overlaps with the geographic area. In some aspects, the network node receives, from the UE, a first indication that the UE will be unable to send uplink (UL) transmissions during a time period associated with a travel path of the UE, wherein the travel path overlaps with the geographic area. FIG. 8 illustrates an example of a network node receiving an indication of a location of a UE. In an example, 1602 may be performed by the aerial UE component 199.

At 1604, the network node transmits, based on a location of the UE being within a geographic area, a configuration for transmission of a measurement report or a conditional handover based on a location of the UE within a geographic area. For example, FIG. 8 at 814 shows that a network node may provide a configuration for devices within a geographic area. In some aspects, the configuration is based on the location of the UE being within the geographic area and further based on a hysteresis condition. In some aspects, the hysteresis condition is based at least one of: entry of the UE into the geographic area and at least a first number of meters inside a boundary of the geographic area, or exit of the UE from the geographic area and at least a second number of meters outside the boundary of the geographic area. In some aspects, the network node transmits, for the UE and based on the measurement report, a second indication of the conditional handover. In some aspects, the configuration includes one or more of a power class switch, a filter configuration, or a power backoff for an uplink (UL) transmission. In some aspects, the configuration is transmitted via an upper layer. In some aspects, the configuration further indicates a time period for which the configuration is valid. In an example, 1604 may be performed by the aerial UE component 199.

In some aspects, the network node receives, from the UE, UE assistance information that includes a first indication that a travel path of the UE overlaps with the geographic area, wherein to transmit the configuration, the at least one processor is configured to transmit the configuration based on the UE assistance information. FIG. 7 illustrates an example of UE assistance information, at 712. In some aspects, the network node receives, from the UE, a first indication that the UE will be unable to send uplink (UL) transmissions during a time period associated with a travel path of the UE, wherein the travel path overlaps with the geographic area, wherein a transmission limitation is associated with the geographic area. FIG. 7 illustrates an example of an indication, at 720.

A UE may be configured with the capability to fly. Such a UE may be referred to as an aerial UE. When an aerial UE is flying and is located within a no transmit zone (NTZ) of a base station, the aerial UE may cause interference to operations of systems that use radio access technologies when the aerial UE transmits in UL. For instance, the interference may be due to an altitude of the aerial UE. In order to avoid causing such interference, an aerial UE may not be allowed to transmit beyond a certain power at a certain frequency band when the aerial UE is located in an NTZ and when the aerial UE is in a flying state. Some wireless communication systems (e.g., 5G NR) may not have a defined manner of configuring an aerial UE to behave in an NTZ. Furthermore, such wireless communication systems may not have a defined manner for an aerial UE to convey NTZ-related information to a base station.

Various technologies pertaining to NTZ signaling for aerial UEs are described herein. In an example, a UE receives, from a network node, a configuration indicating a transmission limitation for a frequency band for aerial devices within a geographic area (e.g., an NTZ). The UE performs at least one of cell selection, cell reselection, measurement reporting, or a conditional handover based on a condition of the UE being an aerial device and based on the configuration indicating the transmission limitation. Vis-à-vis the aforementioned configuration, an aerial UE may perform cell selection, cell reselection, measurement reporting, and/or a conditional handover in a manner that complies with NTZ regulations. As such, vis-à-vis the aforementioned configuration, the aerial UE may avoid causing interference to other RAT-dependent systems near/around a base station.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving, from a network node, a configuration indicating a transmission limitation for a frequency band for aerial devices within a geographic area; and performing at least one of cell selection, cell reselection, measurement reporting, or a conditional handover based on a condition of the UE being an aerial device and based on the configuration indicating the transmission limitation.

Aspect 2 is the method of aspect 1, wherein the transmission limitation includes an indication to not transmit in the frequency band when the UE is within the geographic area and when the UE is the aerial device.

Aspect 3 is the method of any of aspects 1-2, wherein the transmission limitation includes a transmission power limit for transmissions in the frequency band when the UE is within the geographic area and when the UE is the aerial device.

Aspect 4 is the method of any of aspects 1-3, wherein the condition of the UE being the aerial device is based on at least one of: the UE being in an aerial state or at a position above a height threshold, or the UE having an aerial subscription.

Aspect 5 is the method of any of aspects 1-4, wherein the geographic area includes a zone associated with the transmission limitation.

Aspect 6 is the method of aspect 5, wherein the zone is indicated in the configuration as one of: a 3D zone, or a 2D zone and a height range.

Aspect 7 is the method of any of aspects 1-6, further comprising: determining that the UE is within the geographic area, wherein performing at least one of the cell selection, the cell reselection, the measurement reporting, or the conditional handover is further based on the UE being within the geographic area.

Aspect 8 is the method of aspect 7, wherein the configuration is included in a system information block SIB-4, wherein the SIB further includes a second configuration for at least one of the cell selection or the cell reselection, the method further including: overwriting the second configuration with the configuration based on the determination.

Aspect 9 is the method of any of aspects 7-8, wherein the transmission limitation indicates that the UE is to deprioritize the frequency band for at least one the cell selection or the cell reselection when the UE is the aerial device and when the UE is within the geographic area, the method further including: deprioritizing, based on the determination, the frequency band for at least one of the cell selection or the cell reselection.

Aspect 10 is the method of any of aspects 7-9, wherein performing the measurement reporting includes transmitting, for the network node and based on the configuration, a measurement report, wherein the measurement report includes a first indication of a location of the UE.

Aspect 11 is the method of aspect 10, further comprising: receiving, from the network node and based on the measurement report, a second indication of the conditional handover, wherein performing the conditional handover is based on the second indication of the conditional handover.

Aspect 12 is the method of any of aspects 10-11, further comprising: receiving, from the network node and based on the measurement report, a second indication of a power class switch, a third indication of a filter configuration, or a fourth indication of a power backoff for an UL transmission; and performing at least one of the power class switch, filtering, or the power backoff for the UL transmission based on the second indication, the third indication, or the fourth indication, respectively.

Aspect 13 is the method of any of aspects 7-12, wherein determining whether the UE is within the geographic area includes determining whether the UE has entered the geographic area or whether the UE has exited the geographic area, wherein determining whether the UE has entered the geographic area includes determining that the UE has crossed a boundary of the geographic area and is located at least a threshold distance away from the boundary within the geographic area, and wherein determining whether the UE has exited the geographic area includes determining that the UE has crossed the boundary of the geographic area and is located at least the threshold distance away from the boundary outside of the geographic area.

Aspect 14 is the method of any of aspects 8-12, where the SIB comprises a system information block type 4 (SIB-4).

Aspect 15 is the method of any of aspects 1-7 or 9-14, wherein the configuration is included in an RRC release message, and wherein the configuration further indicates a deprioritization request or a cell reselection priority.

Aspect 16 is the method of any of aspects 1-14, wherein the UE is in an RRC inactive state or an RRC active state when the configuration is received.

Aspect 17 is the method of any of aspects 1-7 or 9-14, wherein the configuration is received via an upper layer.

Aspect 18 is the method of any of aspects 1-17, wherein the configuration further indicates a time period for which the configuration is valid, and wherein performing at least one of the cell selection, the cell reselection, the measurement reporting, or the conditional handover occur during the time period.

Aspect 19 is the method of any of aspects 1-18, further comprising: receiving, from a management system an indication of a travel path of the UE that overlaps with the geographic area; and transmitting, for the network node, UE assistance information that includes the indication that the travel path of the UE overlaps with the geographic area, wherein receiving the configuration is further based on the UE assistance information.

Aspect 20 is the method of any of aspects 1-18, further comprising: determining that a travel path of the UE overlaps with the geographic area; and transmitting, for the network node, an indication that the UE will be unable to send UL transmissions on the frequency band during a time period associated with the travel path.

Aspect 21 is an apparatus for wireless communication at a UE, the apparatus comprising at least one memory and at least one processor coupled to the at least one memory and, based at least in part on information stored in the at least one memory, the at least one processor is configured to implement the method of any of aspects 1-20.

Aspect 22 is the apparatus of aspect 21, further comprising at least one of a transceiver or an antenna coupled to that least one processor, wherein to receive the configuration, the at least one processor is configured to receive the configuration via at least one of the transceiver or the antenna.

Aspect 23 is an apparatus for wireless communication at a UE, comprising means for performing the method of any of aspects 1-20.

Aspect 24 is a computer-readable medium storing computer executable code at a UE, the computer executable code, when executed by at least one processor, causes the at least one processor to implement the method of any of aspects 1-20.

Aspect 25 is a method of wireless communication at a network node, including: transmitting, for a UE, a configuration indicating a transmission limitation for a frequency band for aerial devices within a geographic area; and receiving an indication of at least one of cell selection, cell reselection, measurement reporting, or conditional handover based on a condition of the UE being an aerial device and based on the configuration indicating the transmission limitation.

Aspect 26 is the method of aspect 25, wherein the transmission limitation includes a first indication to not transmit in the frequency band when the UE is within the geographic area and when the UE is the aerial device.

Aspect 27 is the method of any of aspects 25-26, wherein the transmission limitation includes a transmission power limit for transmissions in the frequency band when the UE is within the geographic area and when the UE is the aerial device.

Aspect 28 is the method of any of aspects 25-27, wherein the condition of the UE being the aerial device includes at least one of: the UE being in a flying state, or the UE having an aerial subscription.

Aspect 29 is the method of any of aspects 25-28, wherein the geographic area includes a zone associated with the transmission limitation.

Aspect 30 is the method of aspect 29, wherein the zone is indicated in the configuration as one of: a 3D zone, or a 2D zone and a height range.

Aspect 31 is the method of any of aspects 25-30, wherein the configuration is included in a SIB, wherein the SIB further includes a second configuration for at least one of the cell selection or the cell reselection.

Aspect 32 is the method of aspect 31, wherein the SIB comprises a SIB-4.

Aspect 33 is the method of any of aspects 25-32, wherein the transmission limitation indicates that the UE is to deprioritize the frequency band for at least one the cell selection or the cell reselection when the UE is the aerial device and when the UE is within the geographic area.

Aspect 34 is the method of any of aspects 25-32, wherein receiving the indication of at least one of the cell selection, the cell reselection, the measurement reporting, or the conditional handover includes receiving, from the UE, a measurement report, wherein the measurement report includes a first indication of a location of the UE.

Aspect 35 is the method of aspect 34, further comprising: transmitting, for the UE and based on the measurement report, a second indication of the conditional handover.

Aspect 36 is the method of any of aspects 34-35, further comprising: transmitting, for the UE and based on the measurement report, a second indication of a power class switch, a third indication of a filter configuration, or a fourth indication of a power backoff for an UL transmission.

Aspect 37 is the method of any of aspects 25-29 or 33-35, wherein the configuration is included in an RRC release message, and wherein the configuration further indicates a deprioritization request or a cell reselection priority.

Aspect 38 is the method of any of aspects 25-29 or 33-35, wherein the configuration is transmitted via an upper layer.

Aspect 39 is the method of any of aspects 25-38, wherein the configuration further indicates a time period for which the configuration is valid, and wherein receiving the indication of at least one of the cell selection, the cell reselection, the measurement reporting, or the conditional handover occurs during the time period.

Aspect 40 is the method of any of aspects 25-39, further comprising: receiving, from the UE, UE assistance information that includes a first indication that a travel path of the UE overlaps with the geographic area, wherein transmitting the configuration is further based on the UE assistance information.

Aspect 41 is the method of any of aspects 25-39, further comprising: receiving, from the UE, a first indication that the UE will be unable to send UL transmissions during a time period associated with a travel path of the UE, wherein the travel path overlaps with the geographic area.

Aspect 42 is an apparatus for wireless communication at a network node, the apparatus comprising at least one memory and at least one processor coupled to the at least one memory and, based at least in part on information stored in the at least one memory, the at least one processor is configured to implement the method of any of aspects 25-41.

Aspect 43 is the apparatus of aspect 42, further comprising at least one of a transceiver or an antenna coupled to that least one processor, wherein to transmit the configuration, the at least one processor is configured to transmit the configuration via at least one of the transceiver or the antenna.

Aspect 44 is an apparatus for wireless communication at a network node, comprising means for performing the method of any of aspects 25-41.

Aspect 45 is a computer-readable medium storing computer executable code at a network node, the computer executable code, when executed by at least one processor, causes the at least one processor to implement the method of any of aspects 25-41.

Aspect 46 is a method of wireless communication at a UE, comprising: receiving, from a network node, a configuration associated with an RRC inactive state or an RRC idle state, wherein the configuration indicates a transmission limitation for a frequency band for aerial devices within a geographic area; and performing at least one of a cell selection or a cell reselection based on a condition of the UE being an aerial device and based on the configuration indicating the transmission limitation.

In aspect 47, the method of aspect 46 further includes that the transmission limitation includes an indication to not transmit in the frequency band when the UE is within the geographic area and when the UE is the aerial device, or wherein the transmission limitation includes a transmission power limit for transmissions in the frequency band when the UE is within the geographic area and when the UE is the aerial device.

In aspect 48, the method of aspect 46 or 47 further includes that the condition of the UE being the aerial device is based on at least one of: the UE being in an aerial state or at a position above a height threshold, or the UE having an aerial subscription.

In aspect 49, the method of any of aspects 46-48 further includes that the geographic area comprises a zone associated with the transmission limitation, and wherein the zone is indicated in the configuration as one of: a 3D zone, or a 2D zone and a height range.

In aspect 50, the method of any of aspects 46-49 further includes determining that the UE is within the geographic area, wherein to perform at least one of the cell selection or the cell reselection, the at least one processor is configured to perform at least one of the cell selection or the cell reselection according to the configuration based on the UE being within the geographic area.

In aspect 51, the method of aspect 50 further includes that the configuration is a first configuration included in a SIB, wherein the SIB further includes a second configuration for at least one of the cell selection or the cell reselection, the method further comprising: applying the first configuration and not the second configuration based on a determination that the UE is within the geographic area.

In aspect 51, the method of aspect 50 or 51 further includes that the transmission limitation indicates that the UE is to deprioritize the frequency band for at least one the cell selection or the cell reselection when the UE is the aerial device and when the UE is within the geographic area, the method further comprising: deprioritizing, based on a determination that the UE is within the geographic area, the frequency band for at least one of the cell selection or the cell reselection.

In aspect 52, the method of any of aspects 46-51 further includes switching to a different power class configuration based on the UE being within the geographic area.

In aspect 53, the method of any of aspects 46-52 further includes that the configuration is included in an RRC release message, and wherein the configuration further indicates a deprioritization request or a cell reselection priority.

Aspect 54 is an apparatus for wireless communication at a UE, the apparatus comprising at least one memory and at least one processor coupled to the at least one memory and, based at least in part on information stored in the at least one memory, the at least one processor, individually or in any combination, is configured to implement the method of any of aspects 46-53.

Aspect 55 is an apparatus for wireless communication at a UE, the apparatus comprising one or more memories and one or more processors coupled to the one or more memories and, based at least in part on information stored in the one or more memories, the one or more processors, individually or in any combination, are configured to implement the method of any of aspects 46-53.

Aspect 56 is the apparatus of aspect 54 or 55, further comprising at least one of a transceiver or an antenna coupled to that least one processor or the one or more processors.

Aspect 57 is an apparatus for wireless communication at a network node, comprising means for performing the method of any of aspects 46-53.

Aspect 58 is a computer-readable medium (e.g., a non-transitory computer-readable medium) storing computer executable code at a UE, the computer executable code, when executed by at least one processor, causes the at least one processor to implement the method of any of aspects 46-53.

Aspect 59 is a method of wireless communication at a network node, comprising: transmitting, for a UE, a configuration associated with an RRC inactive state or an RRC idle state, wherein the configuration indicates a transmission limitation for a frequency band for aerial devices within a geographic area; and receiving an indication of at least one of a cell selection or a cell reselection based on a condition of the UE being an aerial device and based on the configuration indicating the transmission limitation.

In aspect 60, the method of aspect 59 further includes that the transmission limitation includes a first indication to not transmit in the frequency band when the UE is within the geographic area and when the UE is the aerial device, or wherein the transmission limitation includes a transmission power limit for transmissions in the frequency band when the UE is within the geographic area and when the UE is the aerial device, and, wherein the condition of the UE being the aerial device is based on at least one of: the UE being in an aerial state or at a position above a height threshold, or the UE having an aerial subscription.

In aspect 61, the method of aspect 59 or 60 further includes that the geographic area comprises a zone associated with the transmission limitation, and wherein the zone is indicated in the configuration as one of: a 3D zone, or a 2D zone and a height range.

In aspect 62, the method of any of aspects 59-61 further includes that the configuration is included in a SIB, wherein the SIB further includes a second configuration for at least one of the cell selection or the cell reselection.

In aspect 63, the method of any of aspects 59-62 further includes that the transmission limitation indicates that the UE is to deprioritize the frequency band for at least one the cell selection or the cell reselection when the UE is the aerial device and when the UE is within the geographic area.

In aspect 64, the method of any of aspects 59-63 further includes that the configuration is included in an RRC message, and wherein the configuration further indicates a deprioritization request or a cell reselection priority.

Aspect 65 is an apparatus for wireless communication at a network node, the apparatus comprising at least one memory and at least one processor coupled to the at least one memory and, based at least in part on information stored in the at least one memory, the at least one processor, individually or in any combination, is configured to implement the method of any of aspects 59-63.

Aspect 66 is an apparatus for wireless communication at a network node, the apparatus comprising one or more memories and one or more processors coupled to the one or more memories and, based at least in part on information stored in the one or more memories, the one or more processors, individually or in any combination, are configured to implement the method of any of aspects 59-63.

Aspect 67 is the apparatus of aspect 65 or 66, further comprising at least one of a transceiver or an antenna coupled to that least one processor or the one or more processors.

Aspect 68 is an apparatus for wireless communication at a network node, comprising means for performing the method of any of aspects 59-63.

Aspect 69 is a computer-readable medium (e.g., a non-transitory computer-readable medium) storing computer executable code at a network node, the computer executable code, when executed by at least one processor, causes the at least one processor to implement the method of any of aspects 59-63.

Aspect 70 is a method of wireless communication at a UE, comprising: receiving, from a network node for an RRC connected mode, a configuration associated with a an RRC connected mode, wherein the configuration is for transmission of a measurement report or a conditional handover based on a location of the UE within a geographic area; and performing at least one of the measurement report or the conditional handover based on the configuration.

In aspect 71, the method of aspect 70 further includes that the configuration is based on the location of the UE within the geographic area and further based on a hysteresis condition.

In aspect 72, the method of aspect 71 further includes that the hysteresis condition is based at least one of: entry into the geographic area and at least a first number of meters inside a boundary of the geographic area, or exit from the geographic area and at least a second number of meters outside the boundary of the geographic area.

In aspect 73, the method of aspect 71 further includes that the hysteresis condition is based on entry into the geographic area and at least a first number of meters inside a boundary of the geographic area.

In aspect 74, the method of aspect 71 further includes that the hysteresis condition is based on exit from the geographic area and at least a second number of meters outside the boundary of the geographic area.

In aspect 75, the method of any of aspects 70-74 further includes transmitting, for the network node and based on the configuration, the measurement report, wherein the measurement report includes a first indication of the location of the UE.

In aspect 76, the method of aspect 75 further includes receiving, from the network node and based on the measurement report, a second indication of the conditional handover, wherein to perform the conditional handover, the at least one processor is configured to perform the conditional handover based on the second indication of the conditional handover.

In aspect 77, the method of aspect 75 or 76 further includes receiving, from the network node and based on the measurement report, a second indication of one or more of a power class switch, a filter configuration, or a power backoff for an UL transmission; and performing at least one of the power class switch, filtering, or the power backoff for the UL transmission based on the second indication.

In aspect 78, the method of any of aspects 70-77 further includes that the configuration is received via an upper layer.

In aspect 79, the method of any of aspects 70-78 further includes that the configuration further indicates a time period for which the configuration is valid, and wherein performance of the at least one of the measurement report or the conditional handover is conditional to be performed during the time period indicted for the configuration.

In aspect 80, the method of any of aspects 70-79 further includes receiving, from a management system an indication of a travel path of the UE that overlaps with the geographic area; and transmitting, for the network node, UE assistance information that includes the indication that the travel path of the UE overlaps with the geographic area, wherein the configuration is based on the UE assistance information.

In aspect 81, the method of any of aspects 70-80 further includes that a transmission limitation is associated with the geographic area, and the method further includes determining that a travel path of the UE overlaps with the geographic area; and transmitting, for the network node, an indication that the UE will be unable to send UL transmissions on a frequency band during a time period associated with the travel path.

Aspect 82 is an apparatus for wireless communication at a UE, the apparatus comprising at least one memory and at least one processor coupled to the at least one memory and, based at least in part on information stored in the at least one memory, the at least one processor, individually or in any combination, is configured to implement the method of any of aspects 70-81.

Aspect 83 is an apparatus for wireless communication at a UE, the apparatus comprising one or more memories and one or more processors coupled to the one or more memories and, based at least in part on information stored in the one or more memories, the one or more processors, individually or in any combination, are configured to implement the method of any of aspects 70-81.

Aspect 84 is the apparatus of aspect 82 or 83, further comprising at least one of a transceiver or an antenna coupled to that least one processor or the one or more processors.

Aspect 85 is an apparatus for wireless communication at a network node, comprising means for performing the method of any of aspects 70-81.

Aspect 86 is a computer-readable medium (e.g., a non-transitory computer-readable medium) storing computer executable code at a UE, the computer executable code, when executed by at least one processor, causes the at least one processor to implement the method of any of aspects 70-81.

Aspect 87 is a method of wireless communication at a network node, comprising: receiving an indication of a location of a UE in a RRC connected mode; and transmitting, based on the location of the UE being within a geographic area, a configuration for transmission of a measurement report or a conditional handover.

In aspect 88, the method of aspect 87 further includes that the configuration is based on the location of the UE being within the geographic area and further based on a hysteresis condition.

In aspect 89, the method of aspect 88 further includes that the hysteresis condition is based on at least one of: entry of the UE into the geographic area and at least a first number of meters inside a boundary of the geographic area, or exit of the UE from the geographic area and at least a second number of meters outside the boundary of the geographic area.

In aspect 90, the method of aspect 88 further includes that the hysteresis condition is based on entry of the UE into the geographic area and at least a first number of meters inside a boundary of the geographic area.

In aspect 91, the method of aspect 88 further includes that the hysteresis condition is based on exit of the UE from the geographic area and at least a second number of meters outside the boundary of the geographic area.

In aspect 92, the method of any of aspects 87-91 further includes that the measurement report indicates the location of the UE.

In aspect 93, the method of aspect 92 further includes transmitting, for the UE and based on the measurement report, a second indication of the conditional handover.

In aspect 94, the method of any of aspects 87-93 further includes that the configuration includes one or more of a power class switch, a filter configuration, or a power backoff for an UL transmission.

In aspect 95, the method of any of aspects 87-94 further includes that the configuration is transmitted via an upper layer.

In aspect 96, the method of any of aspects 87-95 further includes that the configuration further indicates a time period for which the configuration is valid.

In aspect 97, the method of any of aspects 87-96 further includes that receiving the indication of the location of the UE includes receiving, from the UE, UE assistance information that includes a first indication that a travel path of the UE overlaps with the geographic area, wherein to transmit the configuration, the at least one processor is configured to transmit the configuration based on the UE assistance information.

In aspect 98, the method of any of aspects 87-96 further includes that receiving the indication of the location of the UE includes receiving receive, from the UE, a first indication that the UE will be unable to send uplink (UL) transmissions during a time period associated with a travel path of the UE, wherein the travel path overlaps with the geographic area, wherein a transmission limitation is associated with the geographic area.

Aspect 99 is an apparatus for wireless communication at a network node, the apparatus comprising at least one memory and at least one processor coupled to the at least one memory and, based at least in part on information stored in the at least one memory, the at least one processor, individually or in any combination, is configured to implement the method of any of aspects 87-98.

Aspect 100 is an apparatus for wireless communication at a network node, the apparatus comprising one or more memories and one or more processors coupled to the one or more memories and, based at least in part on information stored in the one or more memories, the one or more processors, individually or in any combination, are configured to implement the method of any of aspects 87-98.

Aspect 101 is the apparatus of aspect 99 or 100, further comprising at least one of a transceiver or an antenna coupled to that least one processor or the one or more processors.

Aspect 102 is an apparatus for wireless communication at a network node, comprising means for performing the method of any of aspects 87-98.

Aspect 103 is a computer-readable medium (e.g., a non-transitory computer-readable medium) storing computer executable code at a network node, the computer executable code, when executed by at least one processor, causes the at least one processor to implement the method of any of aspects 87-98.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a configuration associated with a radio resource control (RRC) inactive state or an RRC idle state, wherein the configuration indicates a transmission limitation for a frequency band for aerial devices within a geographic area; and
perform at least one of a cell selection or a cell reselection, based on a condition of the UE being an aerial device and based on the configuration indicating the transmission limitation.

2. The apparatus of claim 1, wherein the transmission limitation includes an indication to not transmit in the frequency band when the UE is within the geographic area and when the UE is the aerial device, or wherein the transmission limitation includes a transmission power limit for transmissions in the frequency band when the UE is within the geographic area and when the UE is the aerial device.

3. The apparatus of claim 1, wherein the condition of the UE being the aerial device is based on at least one of:
the UE being in an aerial state or at a position above a height threshold, or
the UE having an aerial subscription.

4. The apparatus of claim 1, wherein the geographic area comprises a zone associated with the transmission limitation, and wherein the zone is indicated in the configuration as one of:
a three-dimensional (3D) zone, or
a two-dimensional (2D) zone and a height range.

5. The apparatus of claim 1, wherein the at least one processor, individually or in any combination, is further configured to:
determine that the UE is within the geographic area, wherein to perform at least one of the cell selection or the cell reselection, the at least one processor is configured to perform at least one of the cell selection or the cell reselection according to the configuration based on the UE being within the geographic area.

6. The apparatus of claim 5, wherein the configuration is a first configuration included in a system information block (SIB), wherein the SIB further includes a second configuration for at least one of the cell selection or the cell reselection, wherein the at least one processor, individually or in any combination, is further configured to:
apply the first configuration and not the second configuration based on a determination that the UE is within the geographic area.

7. The apparatus of claim 5, wherein the transmission limitation indicates that the UE is to deprioritize the frequency band for the at least one of the cell selection or the cell reselection when the UE is the aerial device and when the UE is within the geographic area, wherein the at least one processor, individually or in any combination, is further configured to:
deprioritize, based on a determination that the UE is within the geographic area, the frequency band for at least one of the cell selection or the cell reselection.

8. The apparatus of claim 1, wherein the at least one processor, individually or in any combination, is further configured to:
switch to a different power class configuration based on the UE being within the geographic area.

9. The apparatus of claim 1, wherein the configuration is included in an RRC release message, and wherein the configuration further indicates a deprioritization request or a cell reselection priority.

10. The apparatus of claim 1, further comprising at least one of a transceiver or an antenna coupled to the at least one processor, wherein to receive the configuration, the at least one processor is configured to receive the configuration via at least one of the transceiver or the antenna.

11. An apparatus for wireless communication at a network node, comprising:
at least one memory; and
at least one processor coupled to the at least one memory and, based at least in part on information stored in the at least one memory, the at least one processor, individually or in any combination, is configured to:
transmit, for a user equipment (UE), a configuration associated with a radio resource control (RRC) inactive state or an RRC idle state, wherein the configuration indicates a transmission limitation for a frequency band for aerial devices within a geographic area; and
receive an indication of at least one of a cell selection or a cell reselection, based on a condition of the UE being an aerial device and based on the configuration indicating the transmission limitation.

12. The apparatus of claim 11, wherein the transmission limitation includes a first indication to not transmit in the frequency band when the UE is within the geographic area and when the UE is the aerial device, or wherein the transmission limitation includes a transmission power limit for transmissions in the frequency band when the UE is within the geographic area and when the UE is the aerial device, and, wherein the condition of the UE being the aerial device is based on at least one of:
the UE being in an aerial state or at a position above a height threshold, or
the UE having an aerial subscription.

13. The apparatus of claim 11, wherein the geographic area comprises a zone associated with the transmission limitation, and wherein the zone is indicated in the configuration as one of:
a three-dimensional (3D) zone, or
a two-dimensional (2D) zone and a height range.

14. The apparatus of claim 11, wherein the configuration is included in a system information block (SIB), wherein the SIB further includes a second configuration for at least one of the cell selection or the cell reselection.

15. The apparatus of claim 11, wherein the transmission limitation indicates that the UE is to deprioritize the frequency band for at least one the cell selection or the cell reselection when the UE is the aerial device and when the UE is within the geographic area.

16. The apparatus of claim 11, wherein the configuration is included in an RRC message, and wherein the configuration further indicates a deprioritization request or a cell reselection priority.

17. A method of wireless communication at a user equipment (UE), comprising:
receiving, from a network node, a configuration associated with a radio resource control (RRC) inactive state or an RRC idle state, wherein the configuration indicates a transmission limitation for a frequency band for aerial devices within a geographic area; and
performing at least one of a cell selection or a cell reselection based on a condition of the UE being an aerial device and based on the configuration indicating the transmission limitation.

18. The method of claim 17, wherein the configuration is a first configuration included in a system information block (SIB), wherein the SIB further includes a second configuration for at least one of the cell selection or the cell reselection, the method further comprising:
applying the first configuration and not the second configuration based on a determination that the UE is within the geographic area.

19. The method of claim 17, wherein the transmission limitation indicates that the UE is to deprioritize the frequency band for at least one the cell selection or the cell reselection when the UE is the aerial device and when the UE is within the geographic area, the method further comprising:
deprioritizing, based on a determination that the UE is within the geographic area, the frequency band for at least one of the cell selection or the cell reselection.

20. The method of claim 17, further comprising:
switching to a different power class configuration based on the UE being within the geographic area.
